(19) United States
(12) Patent Application Publication
(10) Pub. No.: US 2025/0220757 A1
(43) Pub. Date: Jul. 3, 2025

(54) ELECTRONIC DEVICE PROVIDING COMMUNICATION FUNCTION AND METHOD FOR OPERATING THE SAME

(71) Applicant: SAMSUNG ELECTRONICS CO., LTD., Suwon-si (KR)

(72) Inventors: Jongho KIM, Suwon-si (KR); Hyejin LEE, Suwon-si (KR); Seolhye WON, Suwon-si (KR); Youna LEE, Suwon-si (KR); Hyewon LEE, Suwon-si (KR)

(73) Assignee: SAMSUNG ELECTRONICS CO., LTD., Suwon-si (KR)

(21) Appl. No.: 18/935,018

(22) Filed: Nov. 1, 2024

Related U.S. Application Data
(63) Continuation of application No. PCT/KR2024/016548, filed on Oct. 28, 2024.

(30) Foreign Application Priority Data
Dec. 29, 2023 (KR) 10-2023-0197244

(51) Int. Cl. H04W 76/20; H04W 8/22; H04W 12/06

(52) U.S. Cl. CPC H04W 76/20; H04W 8/22; H04W 12/06

(57) ABSTRACT

The disclosure relates to an electronic device providing a communication function based on a network environment and a method for operating the same. The electronic device may obtain state information about a plurality of community terminals included in a predetermined community group and, in response to a first community terminal included in the plurality of community terminals being selected as a call target object, output a first state notification message indicating a state of the first community terminal based on the state information. The electronic device may determine a second community terminal among the plurality of community terminals based on the state information in response to a replacement request event for requesting to replace the call target object with another community terminal being triggered, and output a second state notification message indicating a state of the second community terminal based on the state information.

### CROSS-REFERENCE TO RELATED APPLICATIONS

This application is a continuation application of International Application No. PCT/KR2024/016548 designating the United States, filed on Oct. 28, 2024, in the Korean Intellectual Property Receiving Office, which claims priority from Korean Patent Application No. 10-2023-0197244, filed on Dec. 29, 2023, in the Korean Intellectual Property Office, the disclosures of which are hereby incorporated by reference herein in their entireties.

### BACKGROUND

### Field

The disclosure relates to an electronic device providing a communication function based on a network environment and a method for operating the same.

### Description of Related Art

Electronic devices based on communication functions are designed to be easy for users to carry, such as smartphones, mobile phones, or tablet devices. Application programs for providing various functions may be installed on the electronic device. The electronic device may execute an installed application program in response to the user's manipulation. The electronic device may display information according to the execution of an application program through a display.

The electronic device may provide various functions based on interworking with the network environment, and gradually comes in wide use. For example, the electronic device is used in a wide range of areas of life, such as taking photographs, watching content, or authenticating one's identity. Most operations of the electronic device are implemented based on communication functions. For example, a communication function that supports information sharing without time and space constraints (e.g., voice/video calls, text services or short message services) comes up with various services in addition to its major functions. As such, a platform providing various services requires a rapid and stable communication function as a basic requirement.

The above-described information may be provided as related art for the purpose of helping understanding of the disclosure. The foregoing cannot be claimed as, or used to determine, the prior art related to the disclosure.

### SUMMARY

An embodiment of the disclosure may provide a device and method in which an electronic device may replace calling for performing a communication function between community terminals based on state information about community terminals belonging to a community group in a network environment.

According to an embodiment, an electronic device may include a display configured to output visual information, a transceiver configured to perform communication with an external electronic device based on at least one communication scheme, at least one processor, and at least one memory. The at least one memory may include instructions that, when executed, cause the at least one processor to obtain state information about a plurality of community terminals included in a predetermined community group, in response to a first community terminal included in the plurality of community terminals being selected as a call target object, display a first state notification message indicating a state of the first community terminal based on the state information on the display, determine a second community terminal among the plurality of community terminals based on the state information in response to a replacement request event for requesting to replace the call target object with another community terminal being triggered, and display, on the display, a second state notification message indicating a state of the second community terminal based on the state information. The first state notification message or the second state notification message may be a message indicating whether a corresponding community terminal predicted in response to a call is respondable.

According to an embodiment, a method for performing a communication function of an electronic device may include obtaining state information about a plurality of community terminals included in a predetermined community group, in response to a first community terminal included in the plurality of community terminals being selected as a call target object, outputting a first state notification message indicating a state of the first community terminal based on the state information, determining a second community terminal among the plurality of community terminals based on the state information in response to a replacement request event for requesting to replace the call target object with another community terminal being triggered, and outputting a second state notification message indicating a state of the second community terminal based on the state information. The first state notification message or the second state notification message may be a message indicating whether a corresponding community terminal predicted in response to a call is respondable.

According to an embodiment of the disclosure, since the electronic device may call a community terminal considering state information about the community group, it is possible to prevent unnecessary calling of the community terminal in a state in which it may not respond. Further, as the electronic device may receive an automatic configuration message or an automatic response message prepared based on state information from the called community terminal, it may be easy to identify why the corresponding community terminal may not respond.

The technical objects of the disclosure are not limited to the foregoing, and other technical objects may be derived by one of ordinary skill in the art from example embodiments of the disclosure.

Effects of the disclosure are not limited to the foregoing, and other unmentioned effects would be apparent to one of ordinary skill in the art from the following description. In other words, unintended effects in practicing embodiments of the disclosure may also be derived by one of ordinary skill in the art from example embodiments of the disclosure.

### BRIEF DESCRIPTION OF THE DRAWINGS

In connection with the description of the drawings, the same or similar reference denotations may be used for identical or similar elements.

FIG. 1 is a view illustrating a configuration for supporting a communication function in a network environment according to an embodiment of the disclosure;

FIG. 2 is a signal flowchart for supporting a communication function in a network environment according to an embodiment of the disclosure;

FIG. 3 is a state transition view illustrating an electronic device for supporting a communication function in a network environment according to an embodiment of the disclosure;

FIGS. 4A to 4C are control flowcharts for providing a communication function by an electronic device in a network environment according to an embodiment of the disclosure;

FIG. 5 is a control flowchart for providing a communication function by a community terminal in a network environment according to an embodiment of the disclosure;

FIG. 6 is a block diagram illustrating an electronic device for supporting a communication function in a network environment according to an embodiment of the disclosure;

FIG. 7 is a block diagram illustrating a configuration of a community terminal for supporting a communication function in a network environment according to an embodiment of the disclosure;

FIG. 8 is a view illustrating an example of a user interface screen for an electronic device to replace a target for communication according to an embodiment of the disclosure;

FIG. 9 is a view illustrating an example of a user interface screen for an electronic device to provide a state change notification function of a target calling object for communication according to an embodiment of the disclosure;

FIG. 10 is a view illustrating an example of a user interface screen for a replacement calling object to indicate call reception according to an embodiment of the disclosure;

FIGS. 11A and 11B are views illustrating examples of a user interface screen for a called object to transfer an automatic response message according to an embodiment of the disclosure;

FIG. 12A or 12B is a view illustrating an example of transmission of an automatic response message from a called object to a calling object according to an embodiment of the disclosure;

FIGS. 13A to 13C are views illustrating examples of outputting a user interface screen as a community terminal transfers a replacement calling state to a shared device according to an embodiment of the disclosure;

FIG. 14A or 14B is a view illustrating an example of a user interface screen for a user terminal to show the state of group members belonging to a community group according to an embodiment of the disclosure; and

FIG. 14C or 14D is a view illustrating an example of a user interface screen for a shared device to show the state of group members belonging to a community group according to an embodiment of the disclosure.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

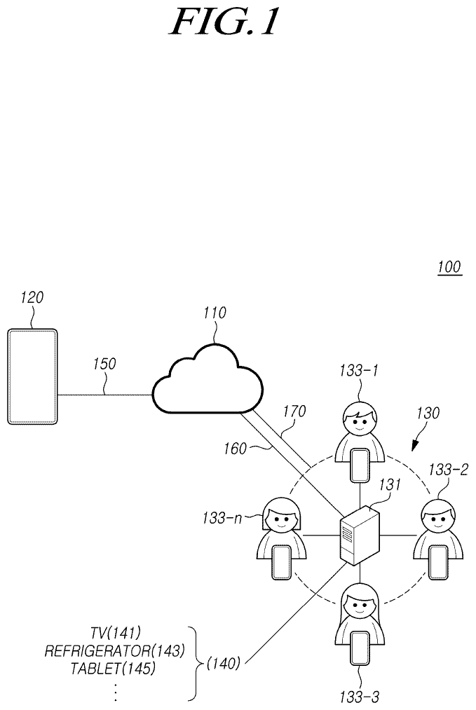

FIG. 1 is a view illustrating a configuration for supporting a communication function in a network environment 100 according to an embodiment of the disclosure.

Referring to FIG. 1, the network environment 100 may support a communication function (e.g., a voice/video call, a text service, or a short message service) of connecting a plurality of nodes through transmission media to exchange signals, information, or data with each other. The network environment 100 may provide a platform for supporting a communication function between the plurality of nodes using the network 110 as a transmission medium. The transmission medium may be based on short-range communication or long-range communication. For the short-range communication, a communication protocol such as Bluetooth, wireless fidelity (Wi-Fi) direct, or infrared data association (IrDA) may be used as a standard. For the long-distance communication, a communication protocol such as legacy cellular, 5G, next-generation communication, the Internet, or a computer network (e.g., LAN or WAN) may be used as a standard.

The plurality of nodes may include hosts capable of executing an application program (or an app) corresponding to a specific event. The hosts may belong to a predetermined community group 130. The hosts included in the community group 130 may be community terminals 133-1, 133-2, 133-3, and 133-n. The community group 130 may include a server 131. The server 131 may manage state information about the community terminals 133-1, 133-2, 133-3, and 133-n. The server 131 may provide state information about the community terminals 133-1, 133-2, 133-3, and 133-n to the electronic device 120, which is one of the hosts.

The electronic device 120 may include a user terminal (e.g., a smart phone, a mobile phone, or a tablet device) carriable by the user, a computer device, a portable multimedia device, a portable medical device, a camera, a wearable device, or a home appliance. The electronic device of the disclosure is not limited to the above-described devices. An application program for providing various functions may be installed in the electronic device 120 or the community terminals 133-1, 133-2, 133-3, and 133-n. The community terminals 133-1, 133-2, 133-3, and 133-nmay execute an installed application program in response to the user's manipulation. The community terminals 133-1, 133-2, 133-3, and 133-n may display information according to execution of the application program through the display.

The shared device 140, which may be included as a node in the network environment 100, may establish a communication link with the community terminals 133-1, 133-2, 133-3, and 133-n. The shared device 140 may include, e.g., a TV 141, a refrigerator 143, or a tablet 145. Further, the shared device 140 may include most devices that may be shared by the community terminals 133-1, 133-2, 133-3, and 133-n.

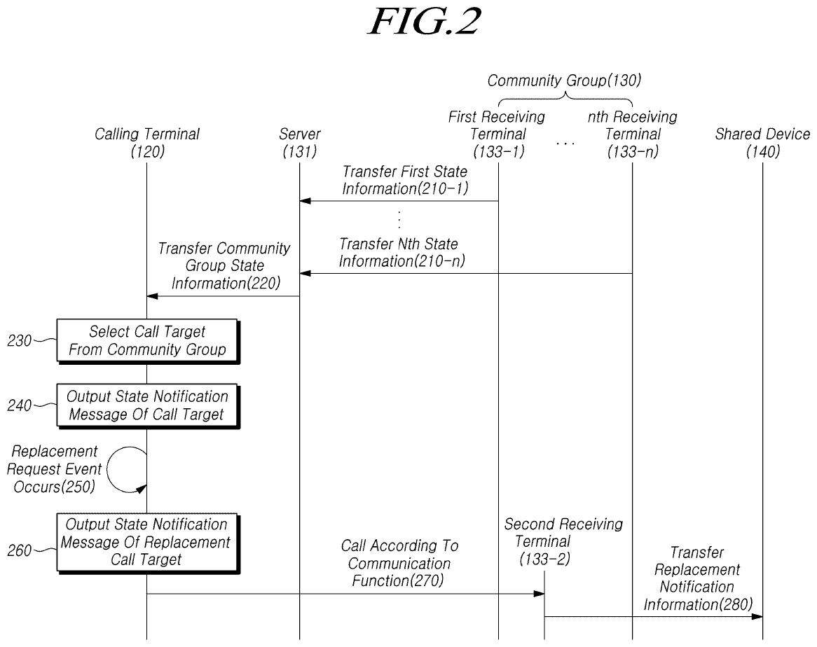

FIG. 2 is a signal flowchart for supporting a communication function in a network environment (e.g., the network environment 100 of FIG. 1) according to an embodiment of the disclosure. In FIG. 2, it is assumed that a communication target is replaced from a first receiving terminal (e.g., the first community terminal 133-1 of FIG. 1) to a second receiving terminal (e.g., the second community terminal 133-2 of FIG. 1). However, the application target may not be the first receiving terminal 133-1 or the second receiving terminal 133-2, but may be another arbitrary receiving terminal (e.g., the nth community terminal 133-n of FIG. 1) included in the community group 130.

Referring to FIG. 2, a plurality of community terminals (e.g., the first to nth receiving terminals 133-1 to 133-n) included in the community group 130 may transfer their state information to the server 131 (operations 210-1 to 210-n). The state information may be used to determine whether the corresponding community terminal is in a state of being capable of responding to a communication request (e.g., voice/video call or text message reception) from the outside. The state information may include, e.g., at least one of operation mode identification information, location information, device connection information, movement information, or remaining battery level information about the corresponding community terminal. The state information may be configured by, e.g., a combination of at least two of operation mode identification information, location information, device connection information, movement information, or battery information about a corresponding community terminal. The operation mode identification information may indicate an operation mode (e.g., a normal operation mode, a work mode, an exercise mode, a movie theater mode, a do-not-disturb mode, or an airplane mode) configured in a corresponding community terminal. The operation mode may be manually set by the user. The operation mode may be automatically set based on information obtained from a sensor or a wearable device (e.g., a smart watch). The location information may indicate the location of the corresponding community terminal. The location information may indicate, e.g., a home, a school, a company, or an unregistered location (e.g., a location obtainable based on information such as GPS). The location information may be manually set by the user. The location information may be automatically set based on information obtained by at least one component (e.g., GPS or ultra-wideband (UWB)). The device connection information may indicate a device (e.g., a vehicle, a smart watch, a Bluetooth speaker, a TV, etc.) to which a corresponding community terminal is connected based on a wireless communication scheme. The device connection information may be information about a connection based on a method such as Bluetooth or Wi-Fi, rather than a method such as near field communication (NFC) for transmitting eventful data as necessary. The movement information may indicate whether a corresponding community terminal is moving. The movement information may indicate a speed at which a corresponding community terminal moves. The battery information may indicate whether the corresponding community terminal needs to be charged. The battery information may indicate the remaining amount of the battery included in the corresponding community terminal.

Table 1 below summarizes examples of state information that may be transferred to the server 131 by a plurality of community terminals (e.g., the first to nth receiving terminals 133-1 to 133-n).

TABLE 1

| Items | Description |
|---|---|
| Operation mode | Work mode, exercise mode, movie theater |
| identification | mode, do-not-disturb mode, airplane mode |
| information | |
| Location information | Home, company, school, other undesignated |
| Device connection | Vehicle BT, smart watch, wireless earphone, |
| information | TV |
| Movement information | Stationary state, moving state (moving speed) |
| Battery information | Whether charging is required, remaining |
| | battery capacity |

According to an embodiment, the plurality of community terminals (e.g., the first to nth receiving terminals 133-1 to 133-n) may periodically transfer their state information to the server 131. A period for transferring the state information to the server 131 may be preset. The period of transferring the state information to the server 131 may be set differently for each community terminal. The period for transferring the state information to the server 131 may be included in system information provided from the server 131 to a community terminal having a communication link. The plurality of community terminals (e.g., the first to nth receiving terminals 133-1 to 133-n) may establish a communication link with the server 131 to periodically transfer state information.

According to an embodiment, the plurality of community terminals (e.g., the first to nth receiving terminals 133-1 to 133-n) may aperiodically transfer their state information to the server 131. For example, the plurality of community terminals (e.g., the first to nth receiving terminals 133-1 to 133-n) may transfer state information to the server 131 in response to a request from the server 131. For example, the plurality of community terminals (e.g., the first to nth receiving terminals 133-1 to 133-n) may transfer state information to the server 131 in response to a change in their state. The states of the plurality of community terminals (e.g., the first to nth receiving terminals 133-1 to 133-n) may include a state in which a response to a communication request is possible (hereinafter, referred to as “respondable state”) or a state in which a response to communication is difficult (hereinafter, referred to as “non-respondable state”). The non-respondable state may be an operation state in which it is difficult to respond to an external call, such as the work mode, the exercise mode, the movie theater mode, the do-not-disturb mode, or the airplane mode. The respondable state may not be the non-respondable state, but may be an operation state of being capable of responding to an external call.

The server 131 may obtain state information transferred by the plurality of community terminals (e.g., the first to nth receiving terminals 133-1 to 133-n) included in the community group 130 (operations 210-1 to 210-n). Although it is illustrated in the drawings that the server 131 collects state information for one community group 130, the disclosure is not limited thereto, and the server 131 may collect state information for the plurality of community groups.

The server 131 may transfer the state information about the community group to a predetermined electronic device (e.g., the calling terminal 120) based on the state information obtained for the community group 130 (operation 220). The server 131 may restrictively transfer the state information about the community group to the calling terminal 120 that legally accesses the community group 130 through an application program installed to share the information about the community group 130.

According to an embodiment, the state information about the community group may be state information obtained corresponding to each of the plurality of community terminals (e.g., the first to nth receiving terminals 133-1 to 133-n). In this case, the state information about the community group may be divided per community terminal using the identifiers and be transferred.

According to an embodiment, the state information about the community group may be generated by processing state information obtained for the community group 130. For example, the state information about the community group may include information for guiding a community terminal capable of responding to a call among the plurality of community terminals (e.g., the first to nth receiving terminals 133-1 to 133-n). For example, the state information about the community group may include information for guiding a community terminal capable of replacing the community terminal capable of responding to a call among the plurality of community terminals (e.g., the first to nth receiving terminals 133-1 to 133-n). For example, the state information about the community group may include information for guiding a nearby shared device accessible by the plurality of community terminals (e.g., the first to nth receiving terminals 133-1 to 133-n).

The calling terminal 120 may obtain state information about the community group transferred by the server 131 (operation 220). The calling terminal 120 may update the existing state information by the obtained state information about the community group. The calling terminal 120 may prepare a recording field of a database for managing the information according to the type of the information included in the state information about the community group.

The calling terminal 120 may select one or more call target objects from among the plurality of community terminals 133-1 to 133-n included in the community group 130 (operation 230). The one or more call target objects may be target community terminals to which the calling terminal 120 is to perform communication (e.g., voice/video call or text transmission). In the following description, it is assumed that the first receiving terminal 133-1 included in the community group 130 is the target community terminal. However, the target community terminal does not have to be specified as the first receiving terminal 133-1, and the same may be equally applied to other community terminals included in the community group 130.

The calling terminal 120 may output a state notification message based on the state information about the call target object (operation 240). The calling terminal 120 may analyze state information obtained for the first receiving terminal 133-1, which is the call target object, and may output a state notification message through the display based on a result of the analysis. The state notification message may be a notification message for notifying the user of whether the first receiving terminal 133-1 is capable of responding to a call according to a communication function. The state notification message may be, e.g., ‘The first user may not respond to the call in the do-not-disturb mode state’. However, when it is analyzed that the first receiving terminal 133-1 is able to respond to the call, the calling terminal 120 may output a state notification message saying, “The first user may respond to the call in the normal operation state”, or may not output the state notification message.

The calling terminal 120 may display, on the display, a call identifier (e.g., an icon or a touch button) for selecting whether to call the first receiving terminal 133-1 while the state notification message is output. When the call identifier is selected, the calling terminal 120 may perform a call procedure for calling the first receiving terminal 133-1.

When the calling terminal 120 calls the first receiving terminal 133-1, the first receiving terminal 133-1 may perform a subsequent operation according to its own operation state. For example, when it is determined that the first receiving terminal 133-1 is unable to respond to the call, the first receiving terminal 133-1 may transmit a preset response message to the calling terminal 120. The preset response message may include, e.g., “I will contact you in a while.” For example, when it is determined that the first receiving terminal 133-1 is unable to respond to the call, the first receiving terminal 133-1 may generate an automatic response message based on the current operation state, and may transmit the generated automatic response message to the calling terminal 120. When determining as participating in class, the first receiving terminal 133-1 may generate an automatic response message including, e.g., “In class. I will call you in an hour” and transfer the automatic response message to the calling terminal 120.

The calling terminal 120 may display, on the display, a search identifier (e.g., an icon or a touch button) capable of requesting to search for a receiving terminal to replace the first receiving terminal 133-1 while the state notification message is output. When the search identifier is selected, the calling terminal 120 may detect that a replacement request event occurs (operation 250).

Upon detecting the occurrence of the replacement request event, the calling terminal 120 may select one or more replacement call objects from among the plurality of community terminals 133-1 to 133-n included in the community group 130 based on the state information. The one or more replacement call objects may be replacement community terminals to which the calling terminal 120 is to perform communication (e.g., voice/video call, text transmission, or the like) on behalf of the first receiving terminal 133-1. For example, the calling terminal 120 may select, as the replacement community terminal, a community terminal positioned close to the first receiving terminal 133-1 or in an operation state of being capable of responding to a call from among the plurality of community terminals 133-1 to 133-n. In the following description, it is assumed that the second receiving terminal 133-2 included in the community group 130 is the replacement community terminal. However, the replacement community terminal does not have to be specified as the second receiving terminal 133-2, and the same may be equally applied to other community terminals included in the community group 130.

The calling terminal 120 may output a state notification message based on the state information about the replacement call object (operation 260). The calling terminal 120 may analyze state information obtained for the second receiving terminal 133-2, which is the replacement call object, and may output a state notification message through the display based on a result of the analysis. The state notification message may be a notification message for notifying the user of whether the second receiving terminal 133-2 is capable of responding to a call according to a communication function. The state notification message may be, e.g., “The second user may respond to the call in the normal operation state”. However, when it is analyzed that the corresponding community terminal is unable to respond to the call, the calling terminal 120 may output a state notification message saying, “The second user may not respond to the call in the do-not-disturb mode”.

The calling terminal 120 may display, on the display, a call identifier (e.g., an icon or a touch button) for selecting whether to call the second receiving terminal 133-2 while the state notification message is output. When the call identifier is selected, the calling terminal 120 may perform a call procedure for calling the second receiving terminal 133-2 (operation 270). The calling terminal 120 may provide identification information indicating that the corresponding call replaces the call of the first receiving terminal 133-1 to the second receiving terminal 133-2. The calling terminal 120 may include the identification information in a message for calling the second receiving terminal 120 and transfer the message. The calling terminal 120 may transfer the identification information separately from the message for calling the second receiving terminal 120.

The second receiving terminal 133-2 may receive the call from the calling terminal 120 (operation 270). The call may be, e.g., a voice call, a video call, or a text transmission. The second receiving terminal 133-2 may identify that the call from the calling terminal 120 replaces the call from the first receiving terminal 133-1, based on the identification information received from the calling terminal 120. The second receiving terminal 133-2 may analyze the identification information and may output the state notification message through the display based on a result of the analysis. The state notification message may be a notification message for notifying the user that it is instead contacted as the first receiving terminal 133-1 is unable to respond to the call. The state notification message may be, e.g., “You are contacted as the first user is not reached. The first user is in class”.

When the second receiving terminal 133-2 identifies that the call transferred by the calling terminal 120 is a replacement call replacing the first receiving terminal 133-1, the second receiving terminal 133-2 may determine whether the notification function by the shared device 140 (e.g., the TV 141, the refrigerator 143, or the tablet 145) is active. The notification function of the shared device 140 may be a function of allowing the shared device 140 to output a notification message notifying that a replacement call occurs. When the notification function of the shared device 140 is active, the second receiving terminal 133-2 may transfer the replacement notification information to the shared device 140 (operation 280). The replacement notification information may include a notification message notifying that the calling terminal 120 calls the second receiving terminal 133-2 instead of the first receiving terminal 133-1.

Upon receiving the replacement notification information from the second receiving terminal 133-2, the shared device 140 may output the notification message included in the replacement notification information using one of visual information and auditory information. The notification message may be “The second recipient has sent the sender's call to the shared device. Should I respond to the call?” The shared device 140 may display a call identifier (e.g., an icon or a touch button) to select whether to respond to the call while the notification message is output. When the call identifier is selected, the shared device 140 may perform a communication procedure in response to the call of the calling terminal 120.

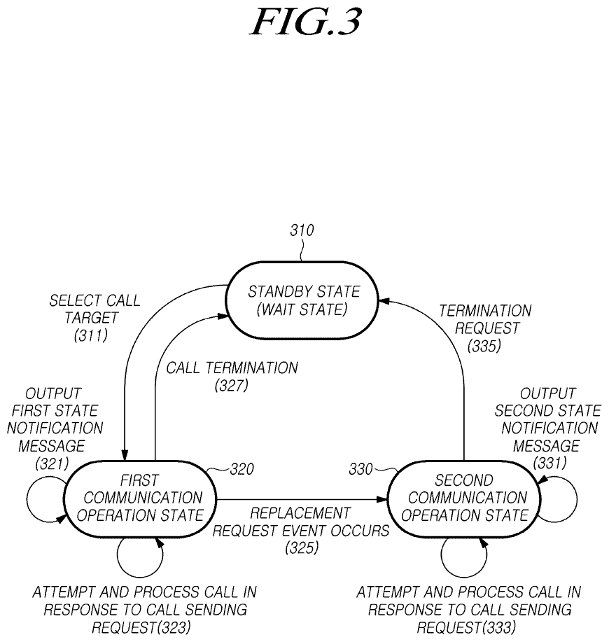

FIG. 3 is a state transition view illustrating an electronic device (e.g., the electronic device 120 of FIG. 1 or the calling terminal 120 of FIG. 2) for supporting a communication function in a network environment (e.g., the network environment 100 of FIG. 1) according to an embodiment of the disclosure. The electronic device 120 operating according to the state transition view illustrated in FIG. 3 may be a third user terminal not included in a community group (e.g., the community group 130 of FIG. 1) or may be a community terminal included in the community group 130. In the following description, it is described that the electronic device 120 performs an operation according to the state transition view, but the same may be performed by a community terminal (e.g., the community terminal 133-1, 133-2, 133-3, 133-n of FIG. 1).

Referring to FIG. 3, the electronic device 120 may operate in a standby state (WAIT STATE) 310 when a function that may be provided, such as a communication function, is not activated. The electronic device 120 may obtain state information about the community group 130 transferred by a server (e.g., the server 131 of FIG. 1) in the standby state 310. For example, the electronic device 120 may legally access the server 131 through a pre-installed application program to collect state information about the community group 130. The state information about the community group may be state information obtained corresponding to the community terminals 133-1, 133-2, 133-3, and 133-n included in the community group 130. The state information about the community group may be generated by processing the state information obtained by the server 131 for the community terminals 133-1, 133-2, 133-3, and 133-n. The state information about the community group may be divided per community terminal using the identifiers and be transferred. The state information about the community group may include information for guiding a community terminal capable of responding to a call among the community terminals 133-1 to 133-n. The state information about the community group may include information for guiding a community terminal capable of replacing the community terminal capable of responding to a call among the community terminals 133-1 to 133-n. The state information about the community group may include information for guiding a nearby shared device accessible by the community terminals 133-1 to 133-n.

The electronic device 120 may update the existing state information by the obtained state information about the community group. The electronic device 120 may prepare a recording field of a database for managing the information according to the type of the information included in the state information about the community group.

When a specific function is activated, the electronic device 120 may transition to an operation state for performing the function (operation 311). For example, when a call target object for communication is selected, the electronic device 120 may transition to the first communication operation state 320. The electronic device 120 may select one or more call target objects from among the plurality of community terminals 133-1 to 133-n included in the community group 130. The one or more call target objects may be target community terminals to which the electronic device 120 is to perform communication (e.g., voice/video call or text transmission).

The electronic device 120 may operate in the first communication operation state 320. For example, the electronic device 120 may output a first state notification message based on state information collected or obtained corresponding to the call target object (operation 321). The call target object may be referred to as a target community terminal (e.g., the first receiving terminal 133-1 of FIG. 1) to be called. For example, the electronic device 120 may analyze state information obtained for the target community terminal selected as the call target object. The electronic device 120 may output a first state notification message corresponding to the target community terminal based on a result of analyzing the state information. The first state notification message may be a notification message for notifying the user of whether the target community terminal is able to respond to a call according to a communication function. The state notification message may be defined differently depending on whether the target community terminal is able to respond to a call according to a communication function.

The electronic device 120 may display, on the display, a call identifier (e.g., an icon or a touch button) capable of requesting a call of the target community terminal while the state notification message is output. When the call identifier is selected, the electronic device 120 may perform a procedure for calling the target community terminal (operation 323). The electronic device 120 may receive a response message from the target community terminal in response to the call. The response message may include content indicating that it is impossible to respond to the call. The response message may be a message previously prepared for the target community terminal to reject a response to a call. The response message may be a message automatically generated by the target community terminal based on its operation state. The message automatically generated based on the operation state may relatively accurately transfer a reason why the recipient may not respond to the call to the sender.

The electronic device 120 may set an alarm for changing the state of the target community terminal in response to outputting the first state notification message indicating that the target community terminal may not respond to the call. In this case, the electronic device 120 may monitor whether the state of the target community terminal is changed based on the state information updated for the target community terminal. When the electronic device 120 recognizes the state change of the target community terminal, the electronic device 120 may output a notification message notifying the same. The electronic device 120 may output an identifier (e.g., an icon or a touch button) capable of calling the target community terminal, together with the notification message, through the display.

The electronic device 120 may monitor whether a replacement request event for requesting to change the call target occurs in response to the output of the first state notification message indicating that the target community terminal may not respond to the call. For example, the electronic device 120 may display, on the display, a search identifier (e.g., an icon or a touch button) capable of requesting to search for a community terminal to replace the target community terminal while the first state notification message is output. When the search identifier is selected, the electronic device 120 may detect that a replacement request event occurs.

When the electronic device 120 detects that the replacement request event occurs, the electronic device 120 may transition to the second communication operation state 330 (operation 325). The electronic device 120 may operate in the second communication operation state 330. When the occurrence of the replacement request event is detected, the electronic device 120 may select one or more replacement call objects from among the plurality of community terminals 133-1 to 133-n included in the community group 130 based on the state information before the state transition. The one or more replacement call objects may be replacement community terminals (e.g., the second receiving terminal 133-2 of FIG. 1) to which the electronic device 120 is to perform communication (e.g., voice/video call or text transmission) on behalf of the target community terminal. For example, the electronic device 120 may select, as the replacement community terminal, a community terminal positioned close to the target community terminal or in an operation state of being capable of responding to a call from among the plurality of community terminals 133-1 to 133-n.

When the replacement community terminal does not exist even when the replacement request event occurs, the electronic device 120 may maintain the first community operation state 320 or may transition to the standby state 310 without transitioning to the second community operation state 330.

When the electronic device 120 transitions to the second communication operation state 330, the electronic device 120 may output a second state notification message based on state information collected or obtained corresponding to the replacement community terminal (operation 331). For example, the electronic device 120 may analyze state information obtained for the replacement community terminal selected as the call target object to be replaced. The electronic device 120 may output a second state notification message corresponding to the replacement community terminal based on a result of analyzing the state information. The second state notification message may be a notification message for notifying the user of whether the replacement community terminal is able to respond to a call according to a communication function. The second state notification message may be defined differently depending on whether the replacement community terminal is able to respond to a call according to a communication function.

The electronic device 120 may display, on the display, a call identifier (e.g., an icon or a touch button) capable of requesting a call of the replacement community terminal while the second state notification message is output. When the call identifier is selected, the electronic device 120 may perform a procedure for calling the replacement community terminal (operation 333). The electronic device 120 may receive a response message from the replacement community terminal in response to the call. The response message may include content indicating that it is impossible to respond to the call. The response message may be a message previously prepared for the replacement community terminal to reject a response to a call. The response message may be a message automatically generated by the replacement community terminal based on its operation state. The message automatically generated based on the operation state may relatively accurately transfer a reason why the recipient may not respond to the call to the sender.

The electronic device 120 may monitor whether termination of the communication function is requested in the first communication operation state 320 or the second communication operation state 330. The termination event of the communication function may occur, e.g., when an application program to perform the corresponding function is terminated. When the termination event of the communication function occurs, the electronic device 120 may transition to the standby state 310 (operation 327 or operation 335). After the state transition, the electronic device 120 may perform an operation in the standby state 310.

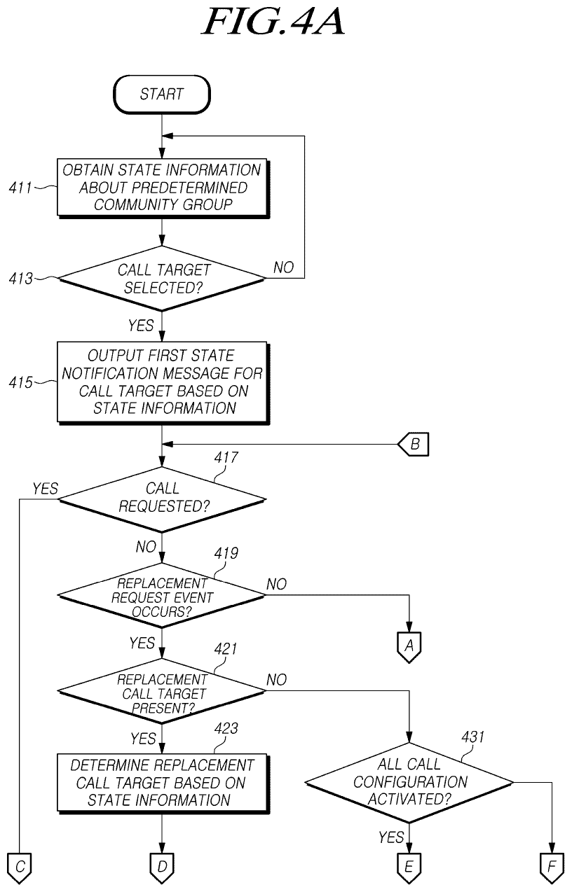

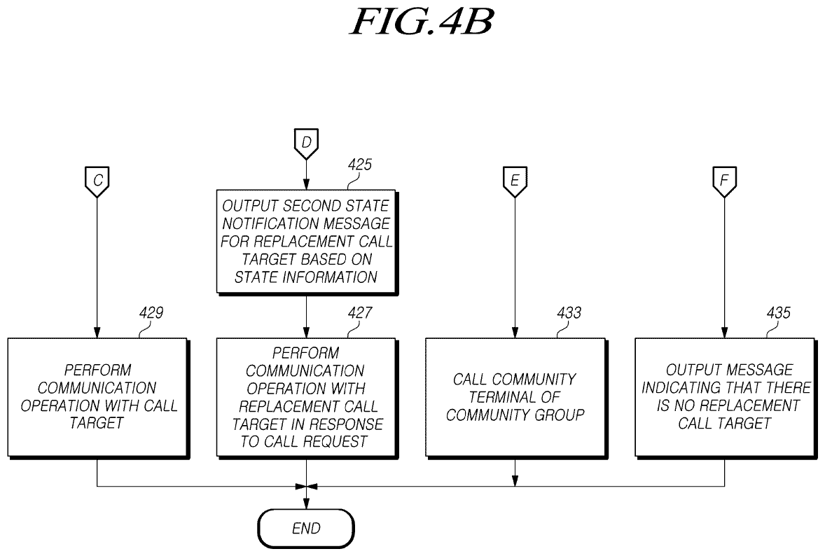

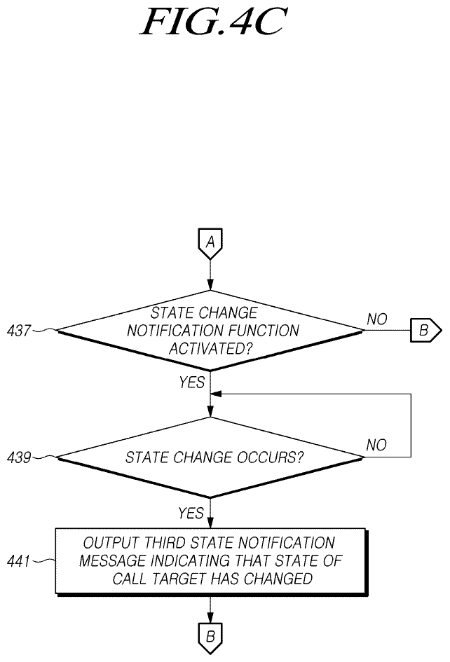

FIGS. 4A to 4C are control flowcharts for providing a communication function by an electronic device (e.g., the electronic device 120 of FIG. 1 or the calling terminal 120 of FIG. 2) in a network environment (e.g., the network environment 100 of FIG. 1) according to an embodiment of the disclosure. The electronic device 120 operating according to the control flowchart illustrated in FIG. 4 may be a third user terminal not included in a community group (e.g., the community group 130 of FIG. 1) or may be a community terminal included in the community group 130. In the following description, it is described that the electronic device 120 performs an operation according to the control flowchart, but the same may be performed by a community terminal (e.g., the community terminal 133-1, 133-2, 133-3, 133-n of FIG. 1).

Referring to FIGS. 4A to 4C, in operation 411, the electronic device 120 may obtain state information about a predetermined community group 130 from a server (e.g., the server 131 of FIG. 1). For example, the electronic device 120 may receive state information about the community group 130 from the server 131 through a pre-installed application program. The state information about the community group may be state information obtained corresponding to the community terminals 133-1, 133-2, 133-3, and 133-n included in the community group 130. The state information about the community group may be generated by processing the state information obtained by the server 131 for the community terminals 133-1, 133-2, 133-3, and 133-n. The state information about the community group may be divided per community terminal using the identifiers and be transferred. The state information about the community group may include information for guiding a community terminal capable of responding to a call among the community terminals 133-1 to 133-n. The state information about the community group may include information for guiding a community terminal capable of replacing the community terminal capable of responding to a call among the community terminals 133-1 to 133-n. The state information about the community group may include information for guiding a nearby shared device accessible by the community terminals 133-1 to 133-n.

The electronic device 120 may update the existing state information by the obtained state information about the community group. The electronic device 120 may prepare a recording field of a database for managing the information according to the type of the information included in the state information about the community group.

In operation 413, the electronic device 120 may determine whether a call target object to perform a communication function (e.g., voice/video call, text transmission, or the like) is selected. The call target object may be selected on the application program running for the communication function. The electronic device 120 may select one or more call target objects from among the plurality of community terminals 133-1 to 133-n included in the community group 130. The one or more call target objects may be target community terminals to which the electronic device 120 is to perform communication.

When the call target object is selected, in operation 415, the electronic device 120 may output a first state notification message based on state information collected or obtained corresponding to the call target object. The call target object may be a target community terminal (e.g., the first receiving terminal 133-1 of FIG. 1) to be called. For example, the electronic device 120 may analyze state information obtained for the target community terminal selected as the call target object. The electronic device 120 may output a first state notification message corresponding to the target community terminal based on a result of analyzing the state information. The first state notification message may be a notification message for notifying the user of whether the target community terminal is able to respond to a call according to a communication function. The state notification message may be defined differently depending on whether the target community terminal is able to respond to a call according to a communication function.

In operation 417, the electronic device 120 may determine whether a call of the call target object is requested. For example, the electronic device 120 may display a call identifier (e.g., an icon or a touch button) on a display, and may identify whether a call is requested for the call target object, based on selection of the call identifier.

When there is a call request for the call target object, the electronic device 120 may perform a communication operation with the call target object in operation 429. The electronic device 120 may receive a response message from the call target object in response to the call. The response message may include content indicating that it is impossible to respond to the call. The response message may be a message previously prepared for the call target object to reject a response to a call. The response message may be a message automatically generated by the call target object based on its operation state. The message automatically generated based on the operation state may relatively accurately transfer a reason why the recipient may not respond to the call to the sender.

In operation 419, the electronic device 120 may monitor whether a replacement request event for requesting to change the call target object occurs in response to the output of the first state notification message. For example, the electronic device 120 may display, on the display, a search identifier (e.g., an icon or a touch button) capable of requesting to search for a target object (hereinafter, referred to as a “replacement target object”) to replace the call target object while the first state notification message is output. When the search identifier is selected, the electronic device 120 may detect that a replacement request event occurs.

In operation 437, the electronic device 120 may determine whether an alarm setting for changing the state of the call target object is activated in response to the output of the first state notification message. The state change may be a change from an operation state in which a call may not be responded to an operation state in which a call may be responded. The electronic device 120 may activate the alarm setting in response to a request from the user.

When the alarm setting is activated, the electronic device 120 may monitor whether a state change of the call target object occurs based on state information updated for the call target object in operation 439. When the electronic device 120 recognizes the state change of the call target object, in operation 441, the electronic device 120 may output a third notification message indicating that the state of the call target body has changed. The electronic device 120 may output an identifier (e.g., an icon or a touch button) capable of calling the call target object, together with the notification message, through the display. After outputting the third notification message, the electronic device 120 may monitor whether a call request is generated in operation 417.

When the replacement request event occurs, the electronic device 120 may determine whether there is a replacement call object in operation 421. For example, the electronic device 120 may select the replacement call object from among the plurality of community terminals 133-1 to 133-n included in the community group 130 based on the state information obtained for the community group 130. The replacement call object may be a replacement community terminal (e.g., the second receiving terminal 133-2 of FIG. 1) to which the electronic device 120 is to perform communication (e.g., voice/video call or text transmission) on behalf of the call target object.

When the replacement call object does not exist even when the replacement request event occurs, the electronic device 120 may determine whether the all call configuration is activated in operation 431. The all call configuration may be a configuration for calling all or some of the community terminals 133-1, 133-2, 133-3, and 133-n included in the community group 130 instead of the call target object.

When the all call configuration is activated, the electronic device 120 may call community terminals corresponding to the plurality of objects set as call targets in operation 433. The plurality of objects may be, e.g., all the community terminals 133-1, 133-2, 133-3, and 133-n included in the community group 130 or remaining community terminals other than the community terminal corresponding to the call target object.

When the all call configuration is not activated, in operation 435, the electronic device 120 may output a fourth notification message indicating that there is no replacement call object. In this case, the electronic device 120 may not perform any further operation for the communication function.

When the replacement call object exists, the electronic device 120 may determine the replacement call object based on the state information obtained corresponding to the community group 130 in operation 423. For example, when a plurality of community terminals among the community terminals 133-1, 133-2, 133-3, and 133-n included in the community group 130 may be selected as replacement call objects, the electronic device 120 may select one replacement call object among the candidate community terminals based on the distance to the community terminal corresponding to the call target object or whether it is in an operation state of being capable of responding to the call.

In operation 425, the electronic device 120 may output a second state notification message based on state information collected or obtained corresponding to the replacement call object. For example, the electronic device 120 may analyze the state information obtained for the community terminal selected as the replacement call object. The electronic device 120 may output a second state notification message corresponding to the replacement call object based on a result of analyzing the state information. The second state notification message may be a notification message for notifying the user of whether the replacement call object is able to respond to a call according to a communication function. The second state notification message may be defined differently depending on whether the replacement call object is able to respond to a call according to a communication function.

The electronic device 120 may display, on the display, a call identifier (e.g., an icon or a touch button) capable of requesting a call of the replacement community terminal while the second state notification message is output. When the call identifier is selected, the electronic device 120 may perform a procedure for calling the replacement community terminal in operation 427. The electronic device 120 may receive a response message from the replacement call object in response to the call. The response message may include content indicating that it is impossible to respond to the call. The response message may be a message previously prepared for the replacement call object to reject a response to a call. The response message may be a message automatically generated by the replacement call object based on its operation state. The message automatically generated based on the operation state may relatively accurately transfer a reason why the recipient may not respond to the call to the sender.

The electronic device 120 may monitor whether a communication function termination event occurs while the above-described operations are performed. The termination event of the communication function may occur, e.g., when an application program to perform the corresponding function is terminated. When the communication function termination event occurs, the electronic device 120 may no longer perform operations according to the communication function.

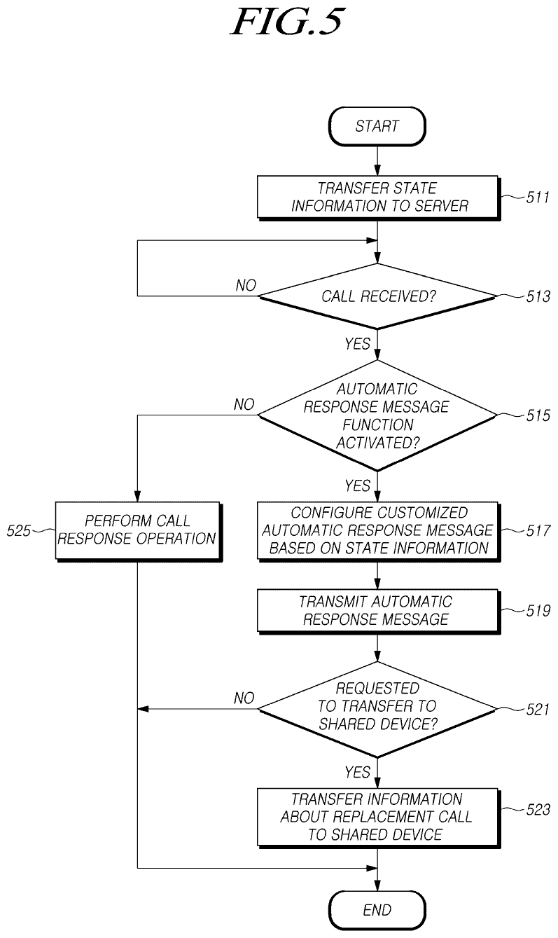

FIG. 5 is a control flowchart for providing a communication function (e.g., voice/video call or text transmission, etc.) by a community terminal (e.g., the community terminals 133-1, 133-2, 133-3, and 133-n of FIG. 1) in a network environment (e.g., the network environment 100 of FIG. 1) according to an embodiment of the disclosure. It is described that the community terminal operating according to the control flowchart illustrated in FIG. 5 is performed by the first community terminal 133-1, which is one of the community terminals 133-1, 133-2, 133-3, and 133-n included in the community group (e.g., the community group 130 of FIG. 1), but the remaining community terminals (e.g., the second to nth community terminals 133-2, 133-3, and 133-n of FIG. 1) may also perform the same operation.

Referring to FIG. 5, in operation 511, the community terminal 133-1 may periodically and/or aperiodically transfer its state information to a server (e.g., the server 131 of FIG. 1). The state information may be used to determine whether the corresponding community terminal is in a state of being capable of responding to a communication request (e.g., voice/video call or text message reception) from the outside. The state information may include, e.g., at least one of operation mode identification information, location information, device connection information, movement information, or remaining battery level information about the corresponding community terminal. The state information may be configured by, e.g., a combination of at least two of operation mode identification information, location information, device connection information, movement information, or battery information about a corresponding community terminal. The operation mode identification information may indicate an operation mode (e.g., a normal operation mode, a work mode, an exercise mode, a movie theater mode, a do-not-disturb mode, or an airplane mode) configured in a corresponding community terminal. The operation mode may be manually set by the user. The operation mode may be automatically set based on information obtained from a sensor or a wearable device (e.g., a smart watch). The location information may indicate the location of the corresponding community terminal. The location information may indicate, e.g., a home, a school, a company, or an unregistered location (e.g., a location obtainable based on information such as GPS). The location information may be manually set by the user. The location information may be automatically set based on information obtained by at least one component (e.g., GPS or UWB). The device connection information may indicate a device (e.g., a vehicle, a smart watch, a Bluetooth speaker, a TV, etc.) to which a corresponding community terminal is connected based on a wireless communication scheme. The device connection information may be information about a connection based on a method such as Bluetooth or Wi-Fi, rather than a method such as NFC for transmitting eventful data as necessary.

The movement information may indicate whether a corresponding community terminal is moving. The movement information may indicate a speed at which a corresponding community terminal moves. The battery information may indicate whether the corresponding community terminal needs to be charged. The battery information may indicate the remaining amount of the battery included in the corresponding community terminal.

In operation 513, the community terminal 133-1 may monitor whether a call is received from a calling terminal (e.g., the electronic device 120 of FIG. 1). The call may include a call and/or a replacement call according to a communication function (e.g., voice/video call or text transmission). The call according to the communication function may be received when the community terminal 133-1 is a call target object. The replacement call may be received when the community terminal 133-1 is a replacement call object.

Upon receiving the call, the community terminal 133-1 may determine whether the automatic response message function is activated in operation 515. The community terminal 133-1 may preferentially determine whether the user responds to the received call before determining whether the automatic response function is activated. The automatic response message function may be a function of generating an automatic response message to be transferred in response to a call based on state information according to its operation state. The automatic response message function allows the user to more accurately deliver a situation in which the user may not respond to a call to the other party.

When the automatic response message function is not activated, the community terminal 133-1 may perform a call response operation in operation 525. The call response operation may include an operation of responding to the call or transferring a preset response message to a counterpart device.

When the automatic response message function is activated, the community terminal 133-1 may configure a customized automatic response message based on the state information in operation 517. For example, the community terminal 133-1 may analyze the location information of “school” and the operation mode of “class mode” based on the state information, and may determine, as the result of the analysis, that the user is participating in class at school based on the location information and/or the operation mode. The community terminal 133-1 may generate a customized automatic response message, such as “In class. I'll call in an hour” based on the determination. In operation 519, the community terminal 133-1 may transfer the generated automatic response message to the calling terminal.

In operation 521, when the call is received, the community terminal 133-1 may determine whether it is requested to transfer generation of a replacement call from the calling terminal to a shared device (e.g., the shared device 140 such as the TV 141, the refrigerator 143, or the tablet 145 of FIG. 1). The notification function by the shared device 140 may be preconfigured in the community terminal 133-1. The notification function of the shared device 140 may be a function of allowing the shared device 140 to output a notification message notifying that a replacement call occurs.

If the notification function by the shared device 140 is activated, the community terminal 133-1 may transfer the replacement notification information to the shared device 140 in operation 523. The replacement notification information may include a notification message indicating that the calling terminal has called the community terminal 133-1 instead of the call target object.

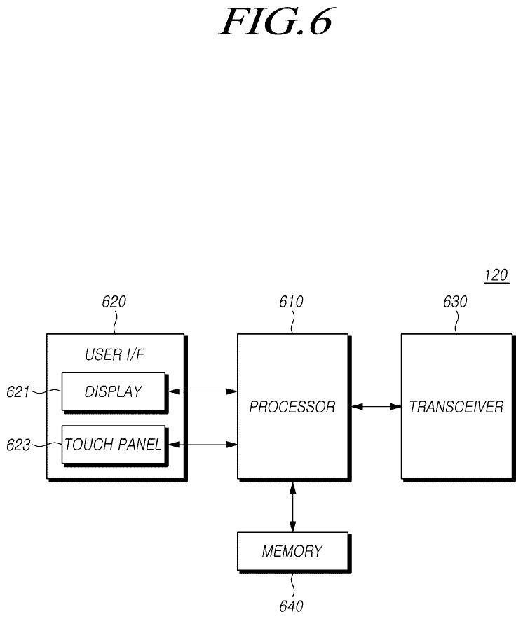

FIG. 6 is a block diagram illustrating a configuration of an electronic device (e.g., the electronic device 120 of FIG. 1 or the calling terminal 120 of FIG. 2) for supporting a communication function in a network environment (e.g., the network environment 100 of FIG. 1) according to an embodiment of the disclosure. The electronic device 120 illustrated in FIG. 6 may be a third user terminal not included in a community group (e.g., the community group 130 of FIG. 1) or may be a community terminal included in the community group 130.

Referring to FIG. 6, an electronic device 120 may include at least one processor 610, a user interface (I/F) 620, a transceiver 630, or at least one memory 640. The processor 610 may be operably connected to the user I/F 620, the transceiver 630, or the at least one memory 640.

The processor 610 may be implemented as one or more integrated circuit (IC) chips and may perform various data processing. For example, the processor 610 (or an application processor (AP)) may be implemented as a system on chip (SoC) (e.g., one chip or chipset). The processor 610 may include sub components including a central processing unit (CPU), a graphics processing unit (GPU), a neural processing unit (NPU), an image signal processor (ISP), a display controller, a memory controller, a storage controller, a communication processor (CP), and/or a sensor interface. The sub components are merely exemplary. For example, processor 610 may further include other sub components. For example, some sub components may be omitted from the processor 610. For example, some sub components may be included as separate components of the electronic device 120 outside the processor 610. For example, some sub components may be included in other components (e.g., a display and an image sensor).

The processor 610 (e.g., a CPU or a central processing circuit) may be configured to control sub components based on execution of instructions stored in the memory 640 (e.g., a volatile memory and/or a non-volatile memory). The GPU (or the graphics processing circuit) may be configured to execute parallel computations (e.g., rendering). The NPU (or neural processing circuit) may be configured to execute operations (e.g., convolution computations) for an artificial intelligence model. The ISP (or the image signal processing circuit) may be configured to process a raw image obtained through the image sensor into a format suitable for a component in the electronic device 120 or a sub component in the processor 610. The display controller (or the display control circuit) may be configured to process an image obtained from the CPU, the GPU, the ISP, or the memory 640 (e.g., a volatile memory) into a format suitable for projection onto the projection surface. The memory controller (or the memory control circuit) may be configured to control to read data from the volatile memory and write the data to the volatile memory. The storage controller (or the storage control circuit) may be configured to read data from the non-volatile memory and control to write the data to the non-volatile memory. The CP (communication processing circuit) may be configured to process the data obtained from the sub component in the processor 610 into a format suitable for transmission to another electronic device (e.g., the server 131 or community terminals 133-1, 133-2, 133-3, and 133-n of FIG. 1) through the transceiver 630 or to process the data obtained from another electronic device (e.g., the server 131 or the community terminals 133-1, 133-2, 133-3, and 133-n of FIG. 1) through the transceiver 630 into a format suitable for the sub component. The sensor interface (or sensing data processing circuit or sensor hub) may be configured to process data about the state of the electronic device 120 and/or the state around the electronic device 120, obtained through an internal sensor (e.g., a time-of-flight (ToF) sensor) or an external sensor (e.g., one or more position measurement sensors (anchors)), into a format suitable for a sub component in the processor 610.

The user I/F 620 may be configured to transmit information to the user. The user I/F 620 may be configured for the user to input information. The user I/F 620 may generate a command or data to be used in a component (e.g., at least one processor 610) of the electronic device 120, in response to the user's manipulation. The user I/F 620 may include a display 621, a touch panel 623, a speaker or a receiver. The user I/F 620 may include a microphone, a mouse, a keyboard, keys (e.g., buttons), or a digital pen (e.g., a stylus pen). The display 621 may output visual information, as a screen, to the user. The touch panel 623 may detect a touch and generate an electrical signal corresponding to the strength, position, area, and/or drag direction of force generated by the touch. The touch panel 623 may include a touch sensor configured to sense a touch, or a pressure sensor configured to measure the intensity of the force generated by the touch. The display 621 and the touch panel 623 may be configured as one hardware device by a stacked structure. The speaker may output sound signals to the outside. The speaker may be used for general purposes, such as playing multimedia or playing record. The receiver may be used for receiving incoming calls. The receiver may be implemented as separate from, or as part of the speaker.

The transceiver 630 may be configured to transmit/receive information, data, or signals to/from at least one electronic device (e.g., the server 131 or community terminals 133-1, 133-2, 133-3, and 133-n of FIG. 1) under the control of the processor 610. The transceiver 630 may include, but is not limited to, a Bluetooth communication unit, a Bluetooth low energy (BLE) communication unit, a near field communication unit, a WLAN (Wi-Fi) communication unit, a Zigbee communication unit, an infrared data association (IrDA) communication unit, a Wi-Fi direct (WFD) communication unit, an ultrawideband (UWB) communication unit, an Ant+ communication unit, or a microwave (uWave) communication unit, corresponding to the performance and structure of the electronic device 120.

The transceiver 630 may support establishment of a wired or wireless communication channel with an external device (e.g., the server 131 or community terminals 133-1, 133-2, 133-3, and 133-n of FIG. 1) and performing communication through the established communication channel. The transceiver 630 may include one or more communication processors supporting wired communication or wireless communication. The one or more communication processors may be operated independently of the processor 610. The transceiver 630 may include, e.g., a wireless communication module (e.g., a cellular communication module, a short-range wireless communication module, or a global navigation satellite system (GNSS) communication module) or a wired communication module (e.g., a local area network (LAN) communication module or a power line communication module). Among the communication modules, a corresponding communication module may communicate with the external device (e.g., the server 131 or community terminals 133-1, 133-2, 133-3, and 133-n of FIG. 1) through the network (e.g., the network 110 of FIG. 1). The network 110 may include a short-range communication network and/or a long-range communication network. The short-range communication network may follow wireless communication standards, such as Bluetooth, wireless fidelity (Wi-Fi) direct or IrDA. The long-range communication network may include, e.g., a legacy cellular network, a 5G network, a next-generation telecommunication network, the Internet, or a computer network (e.g., LAN or WAN). These various types of communication modules may be implemented as a single component (e.g., a single chip), or may be implemented as multi components (e.g., multi chips) separate from each other.

The memory 640 may store various data (e.g., instructions) used by at least one component (e.g., the processor 610) of the electronic device 120. The various data may include, for example, software (e.g., the program) and input data or output data for a command related thereto. The memory 640 may include a volatile memory or a non-volatile memory.

The electronic device 120 may include components not shown. As an example, the electronic device 120 may include a camera. The camera may capture or record still images or videos. The camera may include one or more lenses, image sensors, image signal processors, or flashes.

The electronic device 120 may further include an interface or connecting terminal. The interface may support one or more designated protocols that may be used for the electronic device 120 to make a direct or wireless connection with the external device (e.g., the server 131 or community terminals 133-1, 133-2, 133-3, and 133-n of FIG. 1). The interface may include, e.g., a high definition multimedia interface (HDMI), a universal serial bus (USB) interface, a secure digital (SD) card interface, or an audio interface. The connecting terminal may include a connector through which the electronic device 120 may be physically connected to the external device (e.g., the server 131 or community terminals 133-1, 133-2, 133-3, and 133-n of FIG. 1). The connecting terminal may include, for example, an HDMI connector, a USB connector, an SD card connector, or an audio connector (e.g., a headphone connector).

According to an embodiment, the processor 610 may control the transceiver 630 to obtain state information about the community terminals 133-1, 133-2, 133-3, and 133-n included in a predetermined community group 130 from the server 131. The state information may include at least one of operation mode identification information, location information, device connection information, movement information, or remaining battery level information about the plurality of community terminals. The processor 610 may perform an authentication procedure to obtain the state information. The processor 610 may execute, e.g., a pre-installed application program and perform the authentication procedure through the executed application program.

The processor 610 may select a community terminal (e.g., the first community terminal 133-1) included in the community group 130 as a call target object. The processor 610 may configure a state notification message indicating the state of the call target object based on the state information. The state notification message may be a message for guiding whether the call target object predicted in response to the call is responsive. The processor 610 may control the display 161 to output the state notification message.

The processor 610 may receive a call request of the call target object through the touch panel 623. The state notification message may be a message for indicating whether the call target object predicted in response to the call is respondable. The processor 610 may receive an automatic response message from the call target object through the transceiver 630 in response to the call. The automatic response message may include identification information indicating a cause for being non-respondable based on state information about the call target object.

When the processor 610 recognizes that the call target object has difficulty in responding to the call, the processor 610 may activate the state change notification function to notify that the operation state of the call target object is changed. In this case, the processor 610 may monitor a state change of the call target object based on state information updated for the call target object. When a state change of the call target object is detected, the processor 610 may control the display 621 to display a state notification message for indicating the state change.

The processor 610 may recognize, through the touch panel 623, a trigger of a replacement request event for requesting to replace the call target object with another community terminal. The processor 610 may recognize that the replacement request event is triggered even when the call target object does not respond to the call.

In response to the replacement request event being triggered, the processor 610 may determine another community terminal (e.g., the second community terminal 133-2) included in the community group 130 as the replacement call object based on the state information. When there are a plurality of replacement call objects, the processor 610 may determine one replacement call object considering the distance to the call target object and/or the operation state based on the state information. When the replacement call object does not exist, the processor 610 may control the transceiver 630 to call all of the community terminals 133-1, 133-2, 133-3, and 133-n included in the community group 130 or all of the remaining community terminals 133-2, 133-3, and 133-n other than the first community terminal 133-1, which is the call target object.

The processor 610 may control the display 621 to output a state notification message indicating the state of the replacement call object based on the state information. The state notification message may be a message for indicating whether the replacement call object predicted in response to the call is respondable.

The processor 610 may receive a call request of the replacement call object through the touch panel 623. Upon receiving the call request, the processor 610 may perform a procedure of calling the replacement call object by controlling the transceiver 630. The processor 610 may control the transceiver 630 to transmit, to the replacement call object, information indicating that the corresponding call replaces the call target object while performing the call procedure. The processor 610 may control the transceiver 630 while performing the call procedure to request the replacement call object to transfer indication information indicating that the call is to replace the call target object to a shared device (e.g., the shared device 140 of FIG. 1).

The processor 610 may receive an automatic response message from the replacement call object through the transceiver 630 in response to the call. The automatic response message may include identification information indicating a cause for being non-respondable based on state information about the replacement call object.

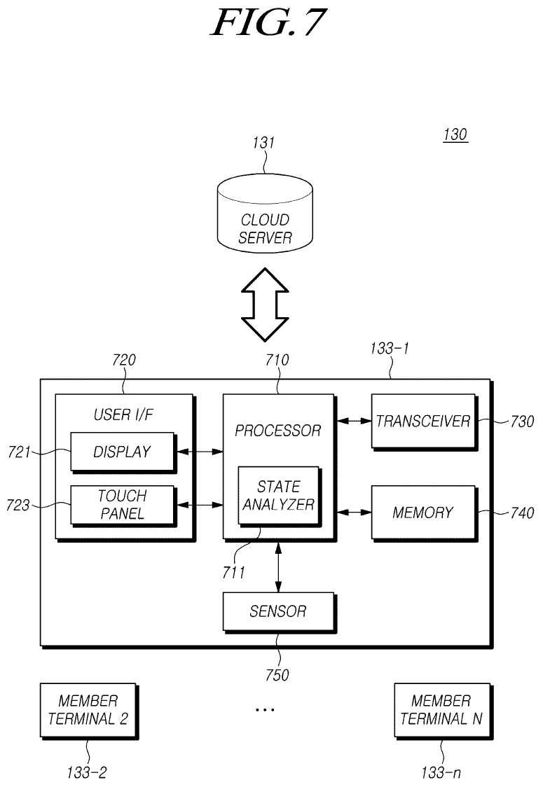

FIG. 7 is a block diagram illustrating a configuration of a community terminal (e.g., the community terminal 133-1, 133-2, 133-3, or 133-n of FIG. 1) for supporting a communication function in a network environment (e.g., the network environment 100 of FIG. 1) according to an embodiment of the disclosure. It is assumed that the community terminal illustrated in FIG. 7 is the first community terminal 133-1 among the community terminals 133-1, 133-2, 133-3, and 133-n included in the community group (e.g., the community group 130 of FIG. 1). However, other community terminals 133-2, 133-3, and 133-n may also perform operations with the same components.

Referring to FIG. 7, a community terminal 133 may include at least one processor 710, a user interface (I/F) 720, a transceiver 730, at least one memory 740, or a sensor 750. The processor 710 may be operably connected to the user I/F 720, the transceiver 730, or the at least one memory 740.

The processor 710 may be implemented as one or more integrated circuit (IC) chips and may perform various data processing. For example, the processor 710 (or an application processor (AP)) may be implemented as a system on chip (SoC) (e.g., one chip or chipset). The processor 710 may include sub components including a central processing unit (CPU), a graphics processing unit (GPU), a neural processing unit (NPU), an image signal processor (ISP), a display controller, a memory controller, a storage controller, a communication processor (CP), and/or a sensor interface. The sub components are merely exemplary. For example, processor 710 may further include other sub components. For example, some sub components may be omitted from the processor 710. For example, some sub components may be included as separate components of the community terminal 133 outside the processor 710. For example, some sub components may be included in other components (e.g., a display and an image sensor).

The processor 710 (e.g., a CPU or a central processing circuit) may be configured to control sub components based on execution of instructions stored in the memory 740 (e.g., a volatile memory and/or a non-volatile memory). The GPU (or the graphics processing circuit) may be configured to execute parallel computations (e.g., rendering). The NPU (or neural processing circuit) may be configured to execute operations (e.g., convolution computations) for an artificial intelligence model. The ISP (or the image signal processing circuit) may be configured to process a raw image obtained through the image sensor into a format suitable for a component in the community terminal 133 or a sub component in the processor 710. The display controller (or the display control circuit) may be configured to process an image obtained from the CPU, the GPU, the ISP, or the memory 740 (e.g., a volatile memory) into a format suitable for projection onto the projection surface. The memory controller (or the memory control circuit) may be configured to control to read data from the volatile memory and write the data to the volatile memory. The storage controller (or the storage control circuit) may be configured to read data from the non-volatile memory and control to write the data to the non-volatile memory. The CP (communication processing circuit) may be configured to process the data obtained from the sub component in the processor 710 into a format suitable for transmission to another electronic device (e.g., the server 131 or community terminals 133-1, 133-2, 133-3, and 133-n of FIG. 1) through the transceiver 730 or to process the data obtained from another electronic device (e.g., the server 131 or the community terminals 133-1, 133-2, 133-3, and 133-n of FIG. 1) through the transceiver 730 into a format suitable for the sub component. The sensor interface (or sensing data processing circuit or sensor hub) may be configured to process data about the state of the community terminal 133 and/or the state around the community terminal 133, obtained through an internal sensor (e.g., a time-of-flight (ToF) sensor) or an external sensor (e.g., one or more position measurement sensors (anchors)), into a format suitable for a sub component in the processor 710.

The user I/F 720 may be configured to transmit information to the user. The user I/F 720 may be configured for the user to input information. The user I/F 720 may generate a command or data to be used in a component (e.g., at least one processor 710) of the community terminal 133, in response to the user's manipulation. The user I/F 720 may include a display 621, a touch panel 623, a speaker or a receiver. The user I/F 720 may include a microphone, a mouse, a keyboard, keys (e.g., buttons), or a digital pen (e.g., a stylus pen). The display 621 may output visual information, as a screen, to the user. The touch panel 623 may detect a touch and generate an electrical signal corresponding to the strength, position, area, and/or drag direction of force generated by the touch. The touch panel 623 may include a touch sensor configured to sense a touch, or a pressure sensor configured to measure the intensity of the force generated by the touch. The display 621 and the touch panel 623 may be configured as one hardware device by a stacked structure. The speaker may output sound signals to the outside. The speaker may be used for general purposes, such as playing multimedia or playing record. The receiver may be used for receiving incoming calls. The receiver may be implemented as separate from, or as part of the speaker.

The transceiver 730 may be configured to transmit/receive information, data, or signals to/from at least one electronic device (e.g., the server 131 or community terminals 133-1, 133-2, 133-3, and 133-n of FIG. 1) under the control of the processor 710. The transceiver 730 may include, but is not limited to, a Bluetooth communication unit, a Bluetooth low energy (BLE) communication unit, a near field communication unit, a WLAN (Wi-Fi) communication unit, a Zigbee communication unit, an infrared data association (IrDA) communication unit, a Wi-Fi direct (WFD) communication unit, an ultrawideband (UWB) communication unit, an Ant+ communication unit, or a microwave (uWave) communication unit, corresponding to the performance and structure of the community terminal 133.

The transceiver 730 may support establishment of a wired or wireless communication channel with an external device (e.g., the server 131 or community terminals 133-1, 133-2, 133-3, and 133-n of FIG. 1) and performing communication through the established communication channel. The transceiver 730 may include one or more communication processors supporting wired communication or wireless communication. The one or more communication processors may be operated independently of the processor 710. The transceiver 730 may include, e.g., a wireless communication module (e.g., a cellular communication module, a short-range wireless communication module, or a global navigation satellite system (GNSS) communication module) or a wired communication module (e.g., a local area network (LAN) communication module or a power line communication module). Among the communication modules, a corresponding communication module may communicate with the external device (e.g., the server 131 or community terminals 133-1, 133-2, 133-3, and 133-n of FIG. 1) through the network (e.g., the network 110 of FIG. 1). The network 110 may include a short-range communication network and/or a long-range communication network. The short-range communication network may follow wireless communication standards, such as Bluetooth, wireless fidelity (Wi-Fi) direct or IrDA. The long-range communication network may include, e.g., a legacy cellular network, a 5G network, a next-generation telecommunication network, the Internet, or a computer network (e.g., LAN or WAN). These various types of communication modules may be implemented as a single component (e.g., a single chip), or may be implemented as multi components (e.g., multi chips) separate from each other.

The memory 740 may store various data (e.g., instructions) used by at least one component (e.g., the processor 710) of the community terminal 133. The various data may include, for example, software (e.g., the program) and input data or output data for a command related thereto. The memory 740 may include a volatile memory or a non-volatile memory.

The sensor 750 may detect an operational state (e.g., power or temperature) of the community terminal 133 or an environmental state (e.g., the user's state) outside the electronic device 100, and generate an electrical signal or data value corresponding to the detected state. The sensor 750 may include, e.g., a gesture sensor, a gyro sensor, an atmospheric pressure sensor, a magnetic sensor, an acceleration sensor, a grip sensor, a proximity sensor, a color sensor, an infrared (IR) sensor, a bio sensor, a temperature sensor, a humidity sensor, or an illuminance sensor.

The community terminal 133 may include components not shown. As an example, the community terminal 133 may include a camera. The camera may capture or record still images or videos. The camera may include one or more lenses, image sensors, image signal processors, or flashes.

The community terminal 133 may further include an interface or connecting terminal. The interface may support one or more designated protocols that may be used for the community terminal 133 to make a direct or wireless connection with the external device (e.g., the server 131 or community terminals 133-1, 133-2, 133-3, and 133-n of FIG. 1). The interface may include, e.g., a high definition multimedia interface (HDMI), a universal serial bus (USB) interface, a secure digital (SD) card interface, or an audio interface. The connecting terminal may include a connector through which the community terminal 133 may be physically connected to the external device (e.g., the server 131 or community terminals 133-1, 133-2, 133-3, and 133-n of FIG. 1). The connecting terminal may include, for example, an HDMI connector, a USB connector, an SD card connector, or an audio connector (e.g., a headphone connector).

According to an embodiment, the processor 710 may control the transceiver 730 to periodically and/or aperiodically transfer its state information to the server 131. The state information may be generated by the state analyzer 711 that may be included in the processor 710. The state analyzer 711 may collect information and/or data for predicting the operation state of the community terminal 133-1 and/or the user's situation, and may generate the state information by analyzing the collected information and/or data. The state information may be used to determine whether the community terminal 133-1 is in a state of being capable of responding to a communication request (e.g., voice/video call or text message reception) from the outside. The state information may include, e.g., at least one of operation mode identification information, location information, device connection information, movement information, or remaining battery level information about the community terminal 133-1. The state information may be configured by, e.g., a combination of at least two of operation mode identification information, location information, device connection information, movement information, or battery information about the community terminal 133-1.

The processor 710 may monitor whether a call is received from a calling terminal (e.g., the electronic device 120 of FIG. 1) through the transceiver 730. The call may include a call and/or a replacement call according to a communication function (e.g., voice/video call or text transmission). The call according to the communication function may be received when the community terminal 133-1 is a call target object. The replacement call may be received when the community terminal 133-1 is a replacement call object.

When the automatic response message function is not activated, the processor 710 may perform a call response operation. The call response operation may include an operation of responding to the call or transferring a preset response message to a counterpart device.

When the automatic response message function is activated, the processor 710 may generate an automatic response message based on state information according to its operation state in response to the call. The automatic response message allows the user to more accurately deliver a situation in which the user may not respond to a call to the other party.

The processor 710 may control the transceiver 730 to transfer the generated automatic response message to the calling terminal.

Upon receiving the call, the processor 710 may determine whether to transfer generation of the replacement call to a shared device (e.g., the shared device 140 such as the TV 141, the refrigerator 143, or the tablet 145 of FIG. 1). The notification function by the shared device 140 may be preconfigured in the community terminal 133-1 or may be requested by the calling terminal. The notification function of the shared device 140 may be a function of allowing the shared device 140 to output a notification message notifying that a replacement call occurs.

If the notification function by the shared device 140 is activated, the processor 710 may transfer the replacement notification information to the shared device 140. The replacement notification information may include a notification message indicating that the calling terminal has called the community terminal 133-1 instead of the call target object.

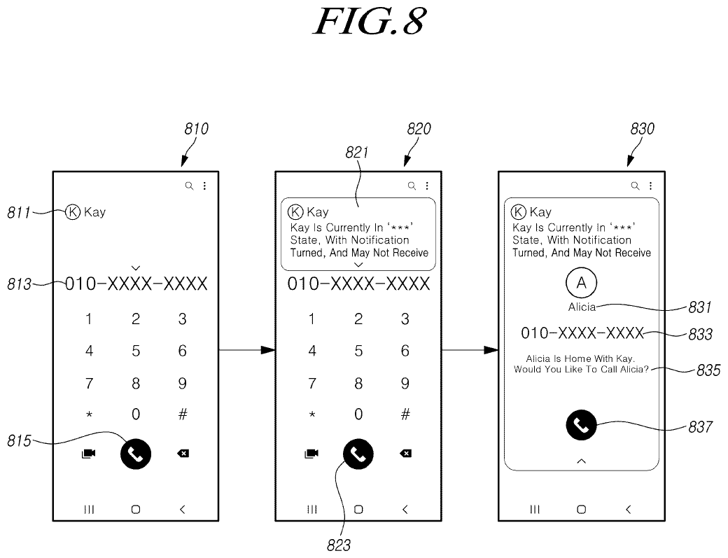

FIG. 8 is a view illustrating an example of a user interface (UI) screen for an electronic device (e.g., the electronic device 120 of FIG. 1) to replace a target for communication according to an embodiment of the disclosure.

Referring to FIG. 8, the electronic device 120 may output a first UI screen 810 for calling the call target object through a display (e.g., the display 621 of FIG. 6) in response to selection of the call target object to perform a specific community function (e.g., voice/video call or text transmission) by the user. The call target object may be one community terminal selected by the user from among a plurality of community terminals (e.g., the community terminals 133-1, 133-2, 133-3, and 133-n of FIG. 1) included in a community group (e.g., the community group 130 of FIG. 1). For example, the first UI screen 810 may include a user name (e.g., Kay) 811 of a call target object, a phone number 813, or an identifier (e.g., an icon or a touch button) 815 for requesting a call.

When the call target object is selected, the electronic device 120 may output, through the display 621, a second UI screen 820 including a state notification message 821 for notifying whether the call target object is able to respond to a call, based on state information obtained or collected corresponding to the call target object. For example, when it is determined that it is difficult for the call target object to respond to the call, the second UI screen 820 may include a state notification message 821 (e.g., “Kay is currently in ‘***’ state, with notification turned off, and may not receive”) indicating the cause of the difficulty in responding to the call. The second UI screen 820 may include an identifier 823 (e.g., an icon or a touch button) capable of requesting a call so as to call the call target object irrespective of the state notification message 821.

When a replacement call is requested by the user, the electronic device 120 may determine a replacement call object that may be called on behalf, and may output the third UI screen 830 through the display 621 based on the state information collected or obtained for the replacement call object. For example, when “Alicia” is determined as the replacement call object, the third UI screen 830 may include a user name (e.g., Alicia) 831 of the replacement call object, a phone number 833, a state notification message 835, or an identifier (e.g., an icon or a touch button) 837 capable of requesting a call of the replacement call object. The state notification message 835 may include content for notifying whether the replacement call object is able to respond to a call based on state information about the replacement call object. For example, the state notification message 835 may include the content “Alicia is home with Kay. Would you like to call Alicia?”

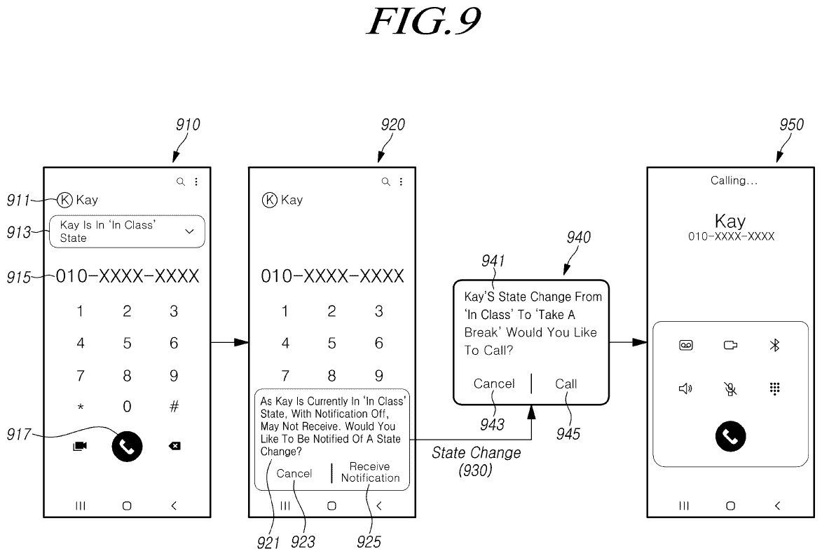

FIG. 9 is a view illustrating an example of a user interface (UI) screen for an electronic device (e.g., the electronic device 120 of FIG. 1) to provide a state change notification function of a target calling object for communication according to an embodiment of the disclosure.

Referring to FIG. 9, the electronic device 120 may output a first UI screen 910 through a display (e.g., the display 621 of FIG. 6) in response to selection of the call target object to perform a specific community function (e.g., voice/video call or text transmission) by the user. The call target object may be one community terminal selected by the user from among a plurality of community terminals (e.g., the community terminals 133-1, 133-2, 133-3, and 133-n of FIG. 1) included in a community group (e.g., the community group 130 of FIG. 1). The first UI screen 910 may include a user name (e.g., Kay) 913 of a call target object, a state notification message 913, a phone number 915, or an identifier (e.g., an icon or a touch button) 815 for requesting a call. The state notification message 913 may include the content (e.g., “Kay is currently in ‘in class’ state”) for notifying whether the call target object is able to respond to a call based on state information obtained or collected corresponding to the call target object.

The electronic device 120 may output, through the display 621, a second UI screen 920 for inquiring whether to configure a state change alarm function for indicating that the state of the call target object is changed. A pop-up window including a notification message 921 and identifiers (e.g., icons or touch buttons) 923 and 925 for setting the state change alarm function in relation to the state change alarm function may be output on the second UI screen 920. For example, the notification message 921 may include the content “Kay is currently ‘in class’ so notification does not sound off and reception may be impossible. Would you like me to notify you if the state changes?” For example, the pop-up window may include an identifier (e.g., cancel 923) for requesting not to set the state change alarm function and/or an identifier (e.g., receive notification 925) for requesting to set the state change alarm function.

When the state change alarm function is set, the electronic device 120 may analyze state information updated for the call target object, and may monitor whether the state of the call target object is changed based on a result of the analysis. When the state change 930 of the call target object occurs, the electronic device 120 may output, through the display 621, a pop-up window 940 including a state notification message 941 for indicating the changed state of the call target object and identifiers 943 and 945 (e.g., icons or touch buttons) for calling the call target object. For example, the notification message 941 may include the content “Kay's state change from ‘in class’ to ‘take a break’ Would you like to call?” For example, the pop-up window may include an identifier (e.g., cancel 943) for selecting not to call the call target object and/or an identifier (e.g., call 945) for selecting to call the call target object.

When the identifier (e.g., call 945) for requesting a call of the call target object is selected, the electronic device 120 may output a third UI screen 950 for calling the call target object through the display 621.

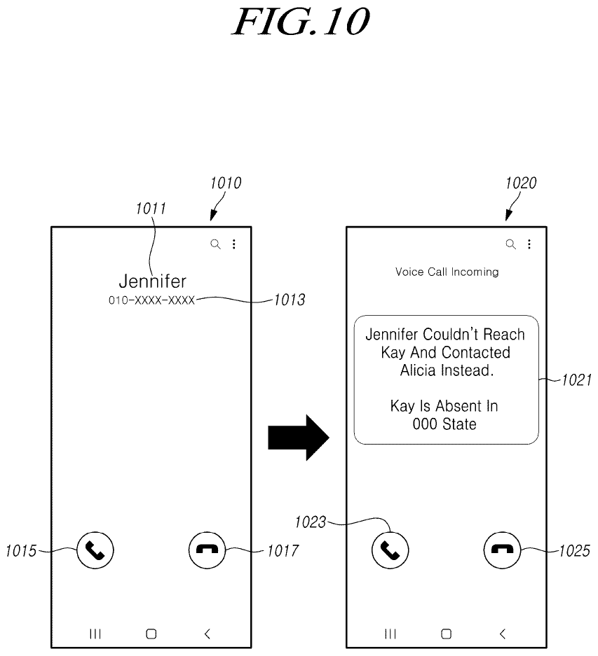

FIG. 10 is a view illustrating an example of a user interface (UI) screen for a replacement calling object (e.g., the community terminals 133-1, 133-2, 133-3, and 133-n of FIG. 1) to indicate call reception according to an embodiment of the disclosure. The replacement call object may be one community terminal 133 selected for a replacement call from among the community terminals 133-1, 133-2, 133-3, and 133-n included in the community group (e.g., the community group 130 of FIG. 1).

Referring to FIG. 10, the community terminal 133 may output, through a display (e.g., the display 721 of FIG. 7), a first UI screen 1010 indicating call reception in response to a call from the outside. The community terminal 133 may be one community terminal selected from a plurality of community terminals (e.g., the community terminals 133-1, 133-2, 133-3, and 133-n of FIG. 1) included in a community group (e.g., the community group 130 of FIG. 1). The first UI screen 1010 may include a name (e.g., Jennifer) 1011 of the called counterpart, a phone number 1013, or identifiers (e.g., icons or touch buttons) 1015 and 1017 for responding to a call.

When the community terminal 133 recognizes that the call is a replacement call, the community terminal 133 may output the second UI screen 1020 for notifying the same through the display 721. The second UI screen 1020 may include a notification message 1021 indicating that it is a replacement call and identifiers (e.g., icons or touch buttons) 1023 and 1025 for responding to the call. For example, the notification message 1021 may include the content “Jennifer couldn't reach Kay and contacted Alicia instead. Kay is absent in 000 state.”

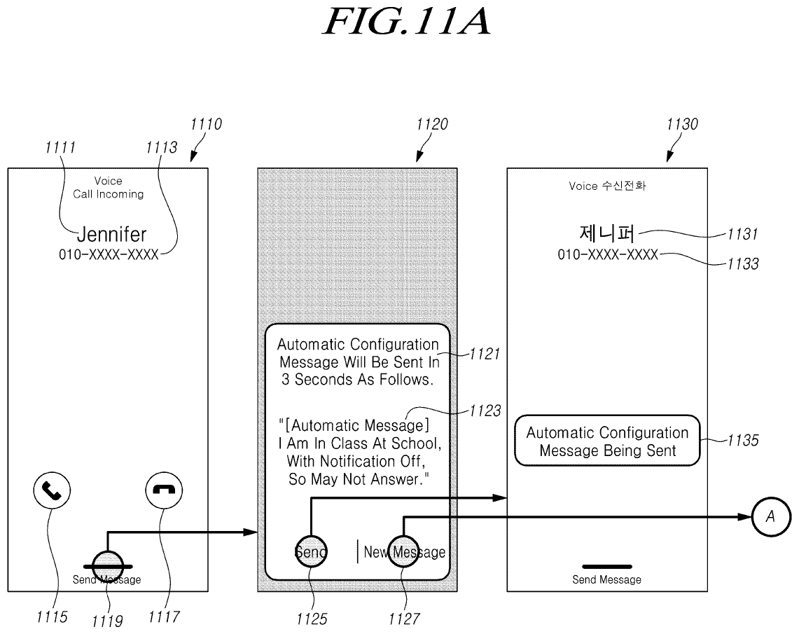

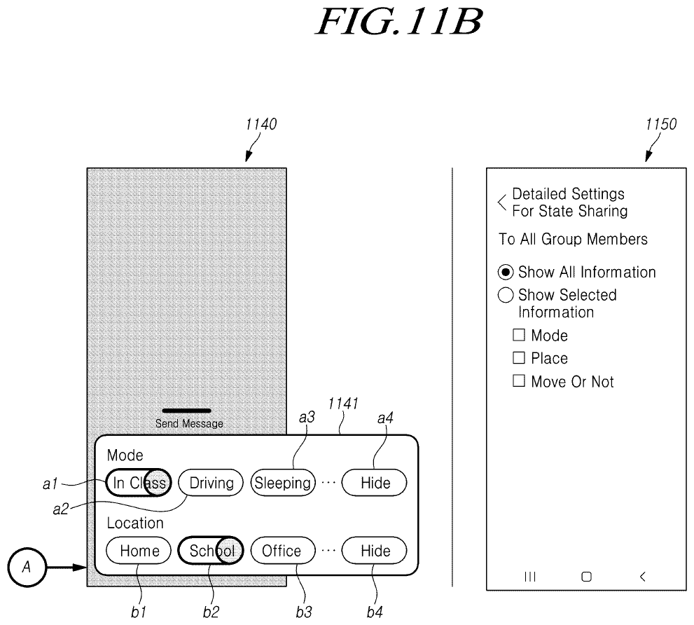

FIGS. 11A and 11B are views illustrating examples of a user interface (UI) screen for a called object (e.g., the community terminals 133-1, 133-2, 133-3, and 133-n of FIG. 1) to transfer an automatic response message according to an embodiment of the disclosure. The called object is an object that performs a call reception operation, and may be a call target object or a replacement call object. The called object may be one of the community terminals 133-1, 133-2, 133-3, and 133-n included in the community group (e.g., the community group 130 of FIG. 1).

Referring to FIGS. 11A and 11B, the community terminal 133 may output, through a display (e.g., the display 721 of FIG. 7), a first UI screen 1110 indicating call reception in response to a call from the outside. The first UI screen 1110 may include a name (e.g., Jennifer) 1111 of the called counterpart, a phone number 1113, identifiers (e.g., icons or touch buttons) 1115 and 1117 for connecting a call in response to the call, or identifiers (e.g., icons or touch buttons) 1119 for sending a message in response to the call.

When the identifier 1119 for sending the message is selected, the community terminal 133 may output a second UI screen 1120 including a pop-up window for indicating the sending of the automatic response message through the display 721. The pop-up window may include a content 1121 (e.g., three seconds later, an automatic configuration message is sent as follows) for indicating the sending of the automatic configuration message, a content 1123 (e.g., “I am in class at school, with notification off, so may not answer”), a first identifier 1125 (e.g., send) for requesting to send the automatic configuration message, or a second identifier 1127 (e.g., ‘new message’) for requesting to re-create an automatic configuration message.

When the first identifier 1125 is selected, the community terminal 133 may output a third UI screen 1130 for sending an automatic configuration message through the display 721. The third UI screen 1130 may include a name 1131 (e.g., Jennifer) of the counterpart to receive the automatic configuration message, a phone number 1133, or a message 1135 indicating that the automatic configuration message is being sent.

When the second identifier 1127 is selected, the community terminal 133 may output a fourth UI screen 1140 for generating an automatic configuration message through the display 721. The fourth UI screen 1140 may include a pop-up window 1141 for selecting information (e.g., an operation mode or a location) for generating an automatic configuration message. The pop-up window 1141 may include, e.g., identifiers for selecting an operation mode (e.g., in class (a1), driving (a2), sleeping (a3), or hide (a4)) and/or identifies for selecting a location (e.g., home (b1), school (b2), office (b3), and/or hide (b4)). The community terminal 133 may collect information necessary for generating an automatic configuration message in response to the user manipulating identifiers included in the pop-up window 1141.

The community terminal 133 may output a fifth UI screen 1150 capable of providing detailed settings for state sharing through the display 721. The fifth UI screen 1150 may be configured to allow the user to select an object (e.g., full information disclosure or selected information disclosure) to share state information, or to select an item (e.g., an operation mode, a place, whether to move, or the like) to be disclosed when the selected information is disclosed.

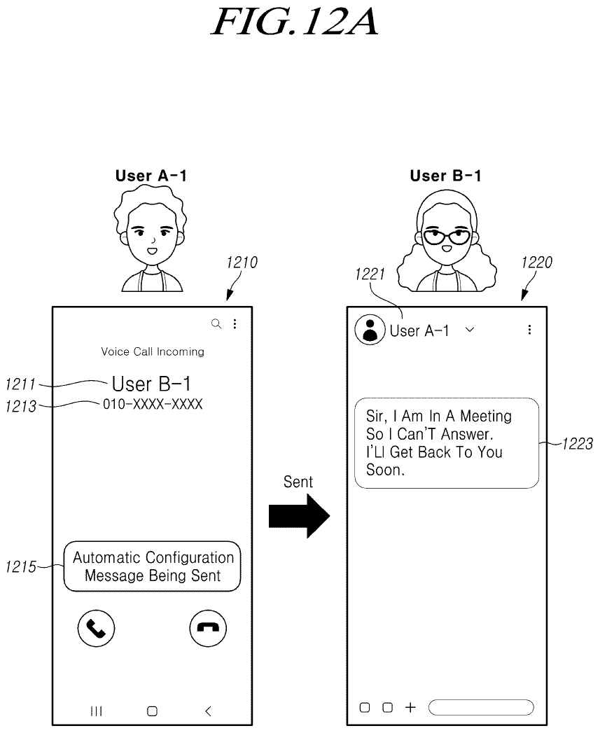

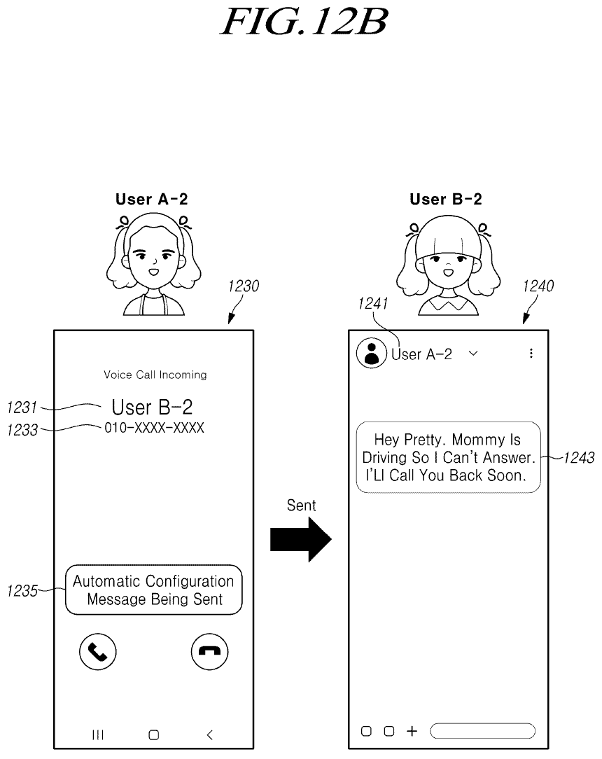

FIG. 12A or 12B is a view illustrating an example of transmission of an automatic response message from a called object (e.g., the community terminals 133-1, 133-2, 133-3, and 133-n of FIG. 1) to a calling object (e.g., the electronic device 120 of FIG. 1) according to an embodiment of the disclosure. The calling object may be an object that performs a call sending operation, and the called object may be an object that performs a call reception operation. The called object may be a call target object or a replacement call object.

Referring to FIG. 12A or 12B, when a calling object 120, which is a terminal of user B-1 (or user B-2), calls a called object 133, which is a terminal of user A-1 (or user A-2), to perform a predetermined communication function, the called object 133 may output a first UI screen 1210 or 1230 corresponding to the call through a display (e.g., the display 721 of FIG. 7). The first UI screen 1210 or 1230 may include the user name (e.g., user B-1 or user B-2) 1211 or 1231 and/or a phone number 1213 or 1233 of the calling object 120. When the automatic response message function is activated in the called object 133, the first UI screen 1210 or 1230 may include a notification message 1215 or 1235 indicating that an automatic configuration message corresponding to the call is generated and sent. The automatic configuration message transmitted by the called object 133 may be transferred to the calling object 120.

The calling object 120 may output a second UI screen 1220 or 1240 including the automatic configuration message received from the called object 133 through a display (e.g., the display 621 of FIG. 6). The second UI screen 1220 or 1240 may include the user name (e.g., user A-1 or user A-2) 1221 or 1241 of the called object 133. The second UI screen 1220 or 1240 may include the content 1223 or 1243 of the automatic configuration message (e.g., “Sir, I'm in a meeting now, so I can't answer. I'll get back to you soon.” or “Hey, Pretty. Mommy is driving, so I can't answer. I'll call you back soon.”).

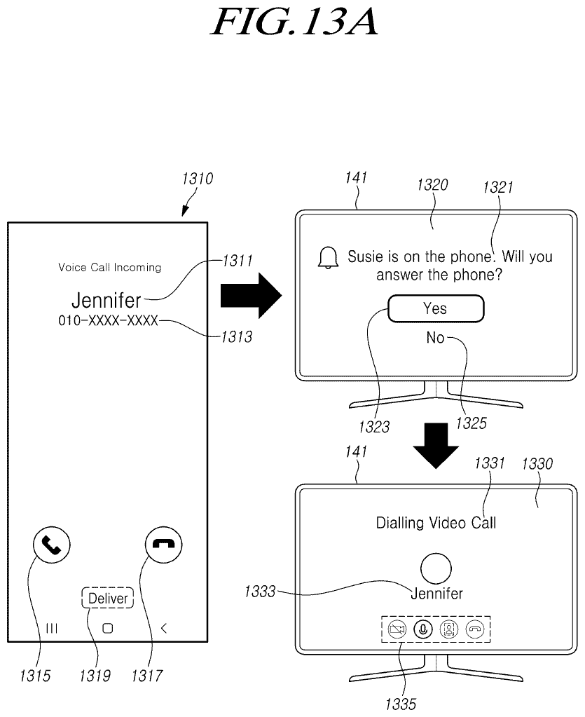

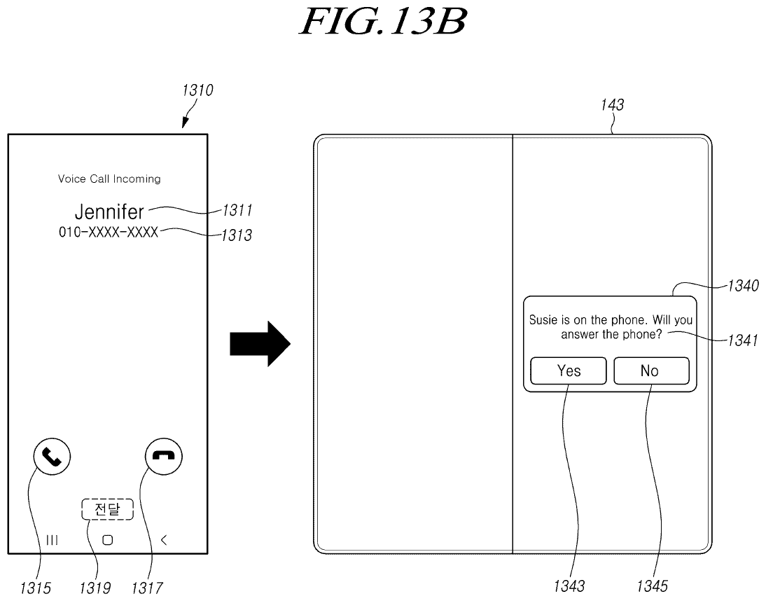

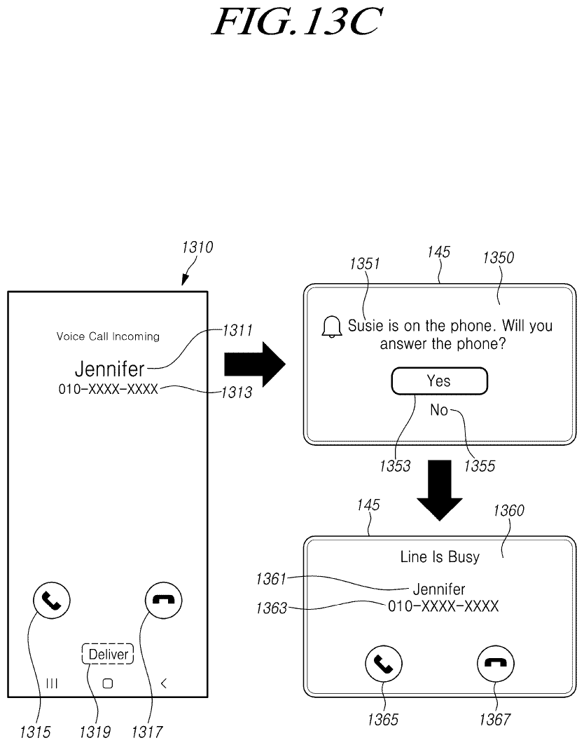

FIGS. 13A to 13C are views illustrating examples of outputting a user interface (UI) screen as a community terminal (e.g., the community terminals 133-1, 133-2, 133-3, and 133-n of FIG. 1) transfers a replacement calling state to a shared device (e.g., the shared device 140 of FIG. 1) according to an embodiment of the disclosure.

Referring to FIGS. 13A to 13C, the community terminal 133 may output, through a display (e.g., the display 721 of FIG. 7), a UI screen 1310 indicating call reception in response to a call from the outside. The community terminal 133 may be one community terminal selected from a plurality of community terminals (e.g., the community terminals 133-1, 133-2, 133-3, and 133-n of FIG. 1) included in a community group (e.g., the community group 130 of FIG. 1). The UI screen 1310 may include a name (e.g., Jennifer) 1311 of the called counterpart, a phone number 1313, first identifiers (e.g., icons or touch buttons) 1315 and 1317 for responding to a call, or second identifiers (e.g., icons or touch buttons) 1319 for requesting to transfer a replacement call situation to the shared devices 141, 143, and 145.

When the second identifier 1319 is selected, the community terminal 133 may transfer, to the shared devices 141, 143, and 145, indication information for indicating a situation in which a call occurs instead of the call target object.

Upon receiving the indication information from the community terminal 133, the shared devices 141, 143, and 145 may output, through the display, screens 1320, 1340, and 1350 for notifying that a replacement call occurs using the indication information. The screens 1320, 1340, and 1350 may include notification messages 1321, 1341, and 1351 (e.g., Susie is on the phone. Will you answer the phone?) or an identifier (e.g., icon or touch button) (1323, 1325 or 1343, 1345 or 1353, 1355) for selecting whether to respond to the call.

When the identifier 1323, 1343, or 1353 for responding to the call is selected, the shared devices 141, 143, and 145 may output, through the display, screens 1330 and 1360 for performing a communication function (e.g., a voice or video call) with the caller (e.g., Jennifer) for the replacement call. For example, the screen 1330 may include identification information 1331 about the communication function, a name (e.g., Jennifer) 1333 of an initial caller who attempts a replacement call, or setting identifiers 1335 for the communication function. For example, the screen 1360 may include a name (e.g., Jennifer) 1361 of an initial caller who attempted to make a replacement call, or an identifier (e.g., call connection 1365 or cancellation 1367) for selecting whether to connect a call.

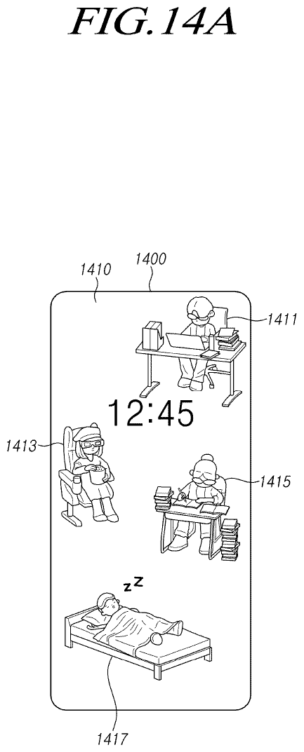

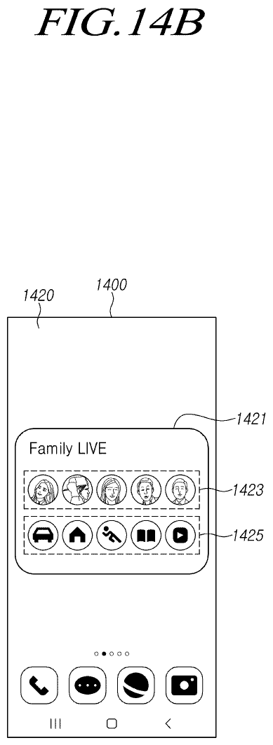

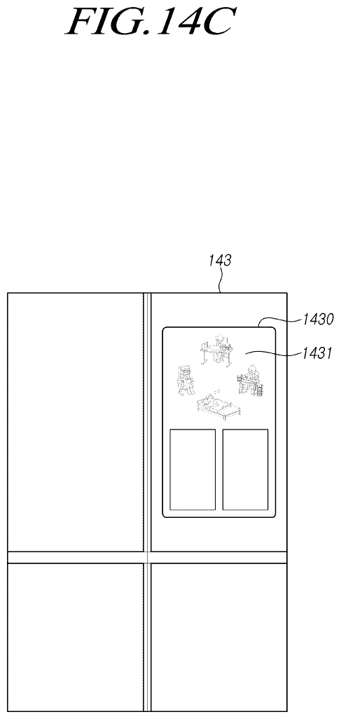

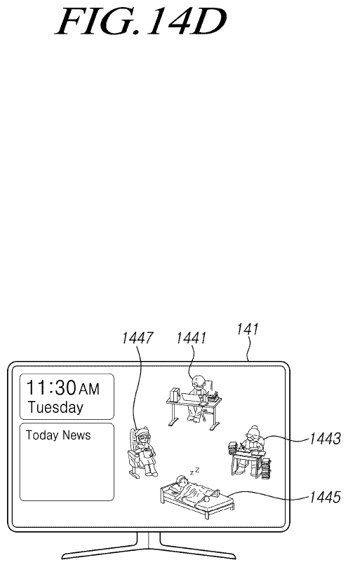

FIG. 14A or 14B is a view illustrating an example of a user interface (UI) screen for a user terminal (e.g., the electronic device 120 or the community terminals 133-1, 133-2, 133-3, and 133-n of FIG. 1) to show the state of group members belonging to a community group (e.g., the community group 130 of FIG. 1) according to an embodiment of the disclosure. The user terminal may be a calling object for performing a call sending operation or a called object for performing a call reception operation. The called object may be a call target object or a replacement call object.

Referring to FIG. 14A, the user terminal 1400 may collect state information about the community terminals 133-1, 133-2, 133-3, and 133-n included in the community group 130, and may output the operation states of the community terminals 133-1, 133-2, 133-3, and 133-n on the display 1410 as visual representations (e.g., avatars) 1411, 1413, 1415, and 1417, based on the collected state information. The visual representation may be an image depicting a current state of a corresponding user predicted using the collected state information. For example, the first visual representation 1411 corresponding to the user of the first community terminal 133-1 may be an image depicting that the user is working. For example, the second visual representation 1413 corresponding to the user of the second community terminal 133-2 may be an image depicting that the user is watching a movie. For example, the third visual representation 1415 corresponding to the user of the third community terminal 133-3 may be an image depicting that the user is studying. For example, the nth visual representation 1415 corresponding to the user of the nth community terminal 133-n may be an image depicting that the user is sleeping. In this case, the user may identify the current state of the group members using the visual representations displayed on the display 1410 of the user terminal 1400.

Referring to FIG. 14B, the user terminal 1400 may collect state information about the community terminals 133-1, 133-2, 133-3, and 133-n included in the community group 130, and may output the operation states of the community terminals 133-1, 133-2, 133-3, and 133-n on the display 1410 through a widget-type pop-up window 1421 based on the collected state information. The widget-type pop-up window 1421 may be a depiction of the current state of each group member predicted using the collected state information using an identifier such as an icon. For example, the widget-type pop-up window 1421 may include an area 1423 for displaying the respective characters of the group members or an area 1425 for displaying an icon indicating the current state of each group member. In this case, the user may identify the current state of the group members using the visual representation displayed on the pop-up window 1421 displayed on the display 1420 of the user terminal 1400.

FIG. 14B or 14D is a view illustrating an example of a user interface (UI) screen for a shared device (e.g., the shared device 140 of FIG. 1) to show the state of group members belonging to a community group (e.g., the community group 130 of FIG. 1) according to an embodiment of the disclosure.

Referring to FIG. 14C, the refrigerator (e.g., the refrigerator 143 of FIG. 1) may collect state information about the community terminals 133-1, 133-2, 133-3, and 133-n included in the community group 130, and may output the operation states of the community terminals 133-1, 133-2, 133-3, and 133-n on the display 1430 as a visual expression (e.g., avatar) 1431 based on the collected state information. The visual representation 1431 may be an image depicting a current state of a corresponding user predicted using the collected state information. In this case, the user may identify the current state of the group members using the visual representation 1431 displayed on the display 1430 of the refrigerator 143.

Referring to FIG. 14D, the TV 141 may collect state information about the community terminals 133-1, 133-2, 133-3, and 133-n included in the community group 130, and may output the operation states of the community terminals 133-1, 133-2, 133-3, and 133-n on the display as visual representations (e.g., avatars) 1441, 1443, 1445, and 1447, based on the collected state information. The visual representation 1441, 1443, 1445, or 1447 may be an image depicting a current state of a corresponding user predicted using the collected state information. In this case, the user may identify the current state of the group members using the visual representations 1441, 1443, 1445, and 1447 displayed on the display of the TV 141.

According to an embodiment, an electronic device 120 may comprise a display 621 configured to output visual information. The electronic device 120 may comprise a transceiver 630 configured to perform communication with an external electronic device based on at least one communication scheme. The electronic device 120 may comprise at least one memory 640 storing at least one instruction. The electronic device 120 may comprise at least one processor 610 including a processing circuit and operably connected to the display 621, the transceiver 630, or the at least one memory 640. The at least one instruction, when executed by at least some of the at least one processor 610, may cause the electronic device 120 to perform at least one operation. The at least one operation may include obtaining state information about a plurality of community terminals 133-1, 133-2, 133-3, 133-n included in a predetermined community group 130. The at least one operation may include, in response to a first community terminal 133-1 included in the plurality of community terminals 133-1, 133-2, 133-3, 133-n being selected as a call target object, displaying a first state notification message indicating a state of the first community terminal 133-1 based on the state information on the display 621. The at least one operation may include determining a second community terminal 133-2 among the plurality of community terminals 133-1, 133-2, 133-3, 133-n based on the state information in response to a replacement request event for requesting to replace the call target object with another community terminal being triggered. The at least one operation may include displaying, on the display 621, a second state notification message indicating a state of the second community terminal 133-2 based on the state information. The first state notification message or the second state notification message may be a message indicating whether a corresponding community terminal predicted in response to a call is respondable.

According to an embodiment, the at least one operation may include performing an authentication procedure for obtaining the state information.

According to an embodiment, the at least one operation may include control the transceiver 630 to receive the state information from a server 131.

According to an embodiment, the state information may include at least one of operation mode identification information, location information, device connection information, movement information, or remaining battery level information about the plurality of community terminals 133-1, 133-2, 133-3, 133-n.

According to an embodiment, the at least one operation may include, in response to a call request for communication with the second community terminal 133-2 while the second state notification message is displayed on the display 621, transferring information indicating being a call replacing the first community terminal 133-1 to the second community terminal 133-2 through the transceiver 630.

According to an embodiment, the at least one operation may include calling the first community terminal 133-1 through the transceiver 630 in response to a call request.

According to an embodiment, the at least one operation may include recognizing that the replacement request event occurs due to rejection of a response to the call.

According to an embodiment, the at least one operation may include, when there is no community terminal to replace the first community terminal 133-1 among the plurality of community terminals 133-1, 133-2, 133-3, 133-n, calling all of the plurality of community terminals 133-1, 133-2, 133-3, 133-n through the transceiver 630.

According to an embodiment, the at least one operation may include activating a state change alarm of the first community terminal 133-1.

According to an embodiment, the at least one operation may include recognizing that a state of the first community terminal 133-1 is changed based on the state information.

According to an embodiment, the at least one operation may include displaying, on the display 621, a third state notification message indicating that the state of the first community terminal 133-1 has been changed.

According to an embodiment, the at least one operation may include receiving an automatic response message from the first community terminal 133-1 or the second community terminal 133-2 through the transceiver 630 in response to a call. The automatic response message may include identification information indicating a cause of being non-respondable based on state information about the first community terminal 133-1 or the second community terminal 133-2.

According to an embodiment, the at least one operation may include, when there are a plurality of community terminals capable of replacing the first community terminal 133-1, determining the second community terminal 133-2 based on a distance from the first community terminal 133-1.

According to an embodiment, the at least one operation may include requesting the second community terminal 133-2 to transfer, to a shared device, indication information indicating having been called instead of the first community terminal 133-1 through the transceiver 630.

According to an embodiment, there may be provided a method for performing a communication function of an electronic device 120. The method may include obtaining state information about a plurality of community terminals 133-1, 133-2, 133-3, 133-n included in a predetermined community group 130. The method may include, in response to a first community terminal 133-1 included in the plurality of community terminals 133-1, 133-2, 133-3, 133-n being selected as a call target object, outputting a first state notification message indicating a state of the first community terminal 133-1 based on the state information. The method may include determining a second community terminal 133-2 among the plurality of community terminals 133-1, 133-2, 133-3, 133-n based on the state information in response to a replacement request event for requesting to replace the call target object with another community terminal being triggered. The method may include outputting a second state notification message indicating a state of the second community terminal 133-2 based on the state information. The first state notification message or the second state notification message may be a message indicating whether a corresponding community terminal predicted in response to a call is respondable.

According to an embodiment, obtaining the state information may include performing an authentication procedure for obtaining the state information and receiving the state information from a server 131.

According to an embodiment, the state information may include at least one of operation mode identification information, location information, device connection information, movement information, or remaining battery level information about the plurality of community terminals 133-1, 133-2, 133-3, 133-n.

According to an embodiment, the method may include, in response to a call request for communication with the second community terminal 133-2 while the second state notification message is displayed on a display 621, transferring information indicating being a call replacing the first community terminal 133-1 to the second community terminal 133-2.

According to an embodiment, determining the second community terminal 133-2 may include calling the first community terminal 133-1 in response to a call request and recognizing that the replacement request event occurs due to rejection of a response to the call.

According to an embodiment, the method may include, when there is no community terminal to replace the first community terminal 133-1 among the plurality of community terminals 133-1, 133-2, 133-3, 133-n, calling all of the plurality of community terminals 133-1, 133-2, 133-3, 133-n.

According to an embodiment, the method may include activating a state change alarm of the first community terminal 133-1, recognizing that a state of the first community terminal 133-1 is changed based on the state information, and outputting a third state notification message indicating that the state of the first community terminal 133-1 has been changed.

According to an embodiment, the method may include receiving an automatic response message from the first community terminal 133-1 or the second community terminal 133-2 in response to a call. The automatic response message may include identification information indicating a cause of being non-respondable based on state information about the first community terminal 133-1 or the second community terminal 133-2.

According to an embodiment, the method may include, when there are a plurality of community terminals capable of replacing the first community terminal 133-1, determining the second community terminal 133-2 based on a distance from the first community terminal 133-1.

According to an embodiment, the method may include requesting the second community terminal 133-2 to transfer, to a shared device 140, indication information indicating having been called instead of the first community terminal 133-1.

According to an embodiment, there may be provided a computer-readable storage medium storing at least one instruction. The at least one instruction, when executed by at least some of the at least one processor 120 of an electronic device, may cause the electronic device to perform at least one operation. The at least one operation may include obtaining state information about a plurality of community terminals 133-1, 133-2, 133-3, 133-n included in a predetermined community group 130. The at least one operation may include, in response to a first community terminal 133-1 included in the plurality of community terminals 133-1, 133-2, 133-3, 133-n being selected as a call target object, displaying a first state notification message indicating a state of the first community terminal 133-1 based on the state information on the display 621. The at least one operation may include determining a second community terminal 133-2 among the plurality of community terminals 133-1, 133-2, 133-3, 133-n based on the state information in response to a replacement request event for requesting to replace the call target object with another community terminal being triggered. The at least one operation may include displaying, on the display 621, a second state notification message indicating a state of the second community terminal 133-2 based on the state information. The first state notification message or the second state notification message may be a message indicating whether a corresponding community terminal predicted in response to a call is respondable.

According to an embodiment, the at least one operation may include performing an authentication procedure for obtaining the state information.

According to an embodiment, the at least one operation may include control the transceiver 630 to receive the state information from a server 131.

According to an embodiment, the state information may include at least one of operation mode identification information, location information, device connection information, movement information, or remaining battery level information about the plurality of community terminals 133-1, 133-2, 133-3, 133-n.

According to an embodiment, the at least one operation may include, in response to a call request for communication with the second community terminal 133-2 while the second state notification message is displayed on the display 621, transferring information indicating being a call replacing the first community terminal 133-1 to the second community terminal 133-2 through the transceiver 630.

According to an embodiment, the at least one operation may include calling the first community terminal 133-1 through the transceiver 630 in response to a call request.

According to an embodiment, the at least one operation may include recognizing that the replacement request event occurs due to rejection of a response to the call.

According to an embodiment, the at least one operation may include, when there is no community terminal to replace the first community terminal 133-1 among the plurality of community terminals 133-1, 133-2, 133-3, 133-n, calling all of the plurality of community terminals 133-1, 133-2, 133-3, 133-n through the transceiver 630.

According to an embodiment, the at least one operation may include activating a state change alarm of the first community terminal 133-1.

According to an embodiment, the at least one operation may include recognizing that a state of the first community terminal 133-1 is changed based on the state information.

According to an embodiment, the at least one operation may include displaying, on the display 621, a third state notification message indicating that the state of the first community terminal 133-1 has been changed.

According to an embodiment, the at least one operation may include receiving an automatic response message from the first community terminal 133-1 or the second community terminal 133-2 through the transceiver 630 in response to a call. The automatic response message may include identification information indicating a cause of being non-respondable based on state information about the first community terminal 133-1 or the second community terminal 133-2.

According to an embodiment, the at least one operation may include, when there are a plurality of community terminals capable of replacing the first community terminal 133-1, determining the second community terminal 133-2 based on a distance from the first community terminal 133-1.

According to an embodiment, the at least one operation may include requesting the second community terminal 133-2 to transfer, to a shared device, indication information indicating having been called instead of the first community terminal 133-1 through the transceiver 630.

According to an embodiment, a program for executing a method for replacing a call according to a community function in the above-described electronic device 120 or the community terminal 133 may be recorded in a computer-readable storage medium.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As an example, a phrase such as “at least one of A, B, or C” may include any of the following: A, B, C, A and B, A and C, B and C, A and B and C. Similarly, as an additional example, a phrase such as “at least one of A, B, and C” may include any of the following: A, B, C, A and B, A and C, B and C, A and B and C. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., the memory 640) that is readable by a machine (e.g., the electronic device 120). For example, a processor (e.g., the processor 610) of the machine (e.g., the electronic device 120) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display configured to output visual information;
a transceiver configured to perform communication with an external electronic device based on at least one communication scheme;
at least one processor; and
at least one memory storing at least one instruction that, when executed, cause the at least one processor to:
obtain state information about a plurality of community terminals included in a predetermined community group,
in response to a first community terminal included in the plurality of community terminals being selected as a call target object, display a first state notification message indicating a state of the first community terminal based on the state information on the display,
determine a second community terminal among the plurality of community terminals based on the state information in response to a replacement request event for requesting to replace the call target object with another community terminal being triggered, and
display, on the display, a second state notification message indicating a state of the second community terminal based on the state information,
wherein the first state notification message or the second state notification message is a message indicating whether a corresponding community terminal predicted in response to a call is respondable.

2. The electronic device of claim 1, wherein the at least one memory includes instructions that, when executed, cause the at least one processor to:
perform an authentication procedure for obtaining the state information, and
control the transceiver to receive the state information from a server,
wherein the state information includes at least one of operation mode identification information, location information, device connection information, movement information, or remaining battery level information about the plurality of community terminals.

3. The electronic device of claim 1, wherein the at least one memory includes instructions that, when executed, cause the at least one processor to:
in response to a call request for communication with the second community terminal while the second state notification message is displayed on the display, transfer information indicating being a call replacing the first community terminal to the second community terminal through the transceiver, and
request the second community terminal to transfer, to a shared device, indication information indicating having been called instead of the first community terminal through the transceiver.

4. The electronic device of claim 1, wherein the at least one memory includes instructions that, when executed, cause the at least one processor to:
call the first community terminal through the transceiver in response to a call request, and
recognize that the replacement request event occurs due to rejection of a response to the call.

5. The electronic device of claim 1, wherein the at least one memory includes instructions that, when executed, cause the at least one processor to:
when there is no community terminal to replace the first community terminal among the plurality of community terminals, call all of the plurality of community terminals through the transceiver.

6. The electronic device of claim 1, wherein the at least one memory includes instructions that, when executed, cause the at least one processor to:
activate a state change alarm of the first community terminal,
recognize that a state of the first community terminal is changed based on the state information, and
display, on the display, a third state notification message indicating that the state of the first community terminal has been changed.

7. The electronic device of claim 1, wherein the at least one memory includes instructions that, when executed, cause the at least one processor to:
receive an automatic response message from the first community terminal or the second community terminal through the transceiver in response to a call,
wherein the automatic response message includes identification information indicating a cause of being non-respondable based on state information about the first community terminal or the second community terminal.

8. The electronic device of claim 1, wherein the at least one memory includes instructions that, when executed, cause the at least one processor to:
when there are a plurality of community terminals capable of replacing the first community terminal, determine the second community terminal based on a distance from the first community terminal.

9. A method for performing a communication function of an electronic device, the method comprising:
obtaining state information about a plurality of community terminals included in a predetermined community group;
in response to a first community terminal included in the plurality of community terminals being selected as a call target object, outputting a first state notification message indicating a state of the first community terminal based on the state information;
determining a second community terminal among the plurality of community terminals based on the state information in response to a replacement request event for requesting to replace the call target object with another community terminal being triggered; and
outputting a second state notification message indicating a state of the second community terminal based on the state information,
wherein the first state notification message or the second state notification message is a message indicating whether a corresponding community terminal predicted in response to a call is respondable.

10. The method of claim 9, wherein obtaining the state information includes:
performing an authentication procedure for obtaining the state information, and
receiving the state information from a server.

11. The method of claim 9, wherein the state information includes at least one of operation mode identification information, location information, device connection information, movement information, or remaining battery level information about the plurality of community terminals.

12. The method of claim 9, further comprising:
in response to a call request for communication with the second community terminal while the second state notification message is displayed on a display, transferring information indicating being a call replacing the first community terminal to the second community terminal;
receiving an automatic response message from the first community terminal or the second community terminal in response to a call;
when there is no community terminal to replace the first community terminal among the plurality of community terminals, calling all of the plurality of community terminals; and
requesting the second community terminal to transfer, to a shared device, indication information indicating having been called instead of the first community terminal,
wherein the automatic response message includes identification information indicating a cause of being non-respondable based on state information about the first community terminal or the second community terminal.

13. The method of claim 9, wherein determining the second community terminal includes:
calling the first community terminal in response to a call request, and
recognizing that the replacement request event occurs due to rejection of a response to the call.

14. The method of claim 9, further comprising:
activating a state change alarm of the first community terminal;
recognizing that a state of the first community terminal is changed based on the state information; and
outputting a third state notification message indicating that the state of the first community terminal has been changed.

15. The method of claim 9, further comprising:
when there are a plurality of community terminals capable of replacing the first community terminal, determining the second community terminal based on a distance from the first community terminal.

16. One or more non-transitory computer-readable storage media storing one or more computer programs including computer-executable instructions that, when executed by one or more processors of an electronic device individually or collectively, cause the electronic device to perform operations, the operations comprising:
obtaining state information about a plurality of community terminals included in a predetermined community group;
in response to a first community terminal included in the plurality of community terminals being selected as a call target object, outputting a first state notification message indicating a state of the first community terminal based on the state information;
determining a second community terminal among the plurality of community terminals based on the state information in response to a replacement request event for requesting to replace the call target object with another community terminal being triggered; and
outputting a second state notification message indicating a state of the second community terminal based on the state information,
wherein the first state notification message or the second state notification message is a message indicating whether a corresponding community terminal predicted in response to a call is respondable.

17. The one or more non-transitory computer-readable storage media of claim 16, wherein obtaining the state information includes:
performing an authentication procedure for obtaining the state information, and
receiving the state information from a server.

18. The one or more non-transitory computer-readable storage media of claim 16, the operations further comprising:
activating a state change alarm of the first community terminal;
recognizing that a state of the first community terminal is changed based on the state information; and
outputting a third state notification message indicating that the state of the first community terminal has been changed.

19. The one or more non-transitory computer-readable storage media of claim 16, wherein determining the second community terminal includes:
calling the first community terminal in response to a call request, and
recognizing that the replacement request event occurs due to rejection of a response to the call.

20. The one or more non-transitory computer-readable storage media of claim 16, the operations further comprising:
when there are a plurality of community terminals capable of replacing the first community terminal, determining the second community terminal based on a distance from the first community terminal.
